(19) United States
(12) Patent Application Publication
(10) Pub. No.: US 2024/0002693 A1
(43) Pub. Date: Jan. 4, 2024

(54) ACTIVE COATING BASED ON PICKERING EMULSIONS

(71) Applicants: The State of Israel, Ministry of Agriculture & Rural Development, Agriculture Research Organization, Rishon Lezion (IL); BAR ILAN UNIVERSITY, Ramat Gan (IL)

(72) Inventors: Guy MECHREZ, Adi (IL); Karthik Ananth MANI, Rishon Lezion (IL); Mor MAAYAN, Modiin (IL); Ehud BANIN, Tel-Aviv (IL)

(21) Appl. No.: 18/369,360

(22) Filed: Sep. 18, 2023

Related U.S. Application Data
(63) Continuation of application No. PCT/IL2022/050300, filed on Mar. 16, 2022.
(60) Provisional application No. 63/161,478, filed on Mar. 16, 2021.

(51) Int. Cl. C09D 183/04; C09D 5/14; C09D 7/20; C09D 7/40; C08K 3/36; C08J 7/04

(52) U.S. Cl. CPC C09D 183/04; C09D 5/14; C09D 7/20; C09D 7/69; C08K 3/36; C08J 7/04; C08J 2383/04

(57) ABSTRACT

A composition comprising an emulsion comprising a plurality of particles is provided. An article comprising a substrate, and a plurality of particles comprising a core and a shell, wherein the plurality of particles are in the form of a coating layer on the substrate is provided. Further, a method for coating a substrate is provided.

### CROSS-REFERENCE TO RELATED APPLICATIONS

This application is a Bypass Continuation of PCT Patent Application No. PCT/IL2022/050300 having International filing date of Mar. 16, 2022, which claims the benefit of priority of U.S. Provisional Patent Application No. 63/161,478, titled “ACTIVE COATING BASED ON PICKERING EMULSIONS”, filed Mar. 16, 2021. The contents of which are incorporated herein by reference in their entirety.

### FIELD OF THE INVENTION

The present invention is in the field of Pickering emulsions.

### BACKGROUND OF THE INVENTION

Pickering emulsions are typically known as emulsions of any type, for example oil-in-water or water-in-oil, stabilized by solid particles in place of surfactants. Pickering emulsions are stabilized by nanoparticles (NPs) that are self-assembled typically at the oil-water interface and acts as a physical barrier.

### SUMMARY OF THE INVENTION

In one aspect, there is a composition, comprising a core-shell particle dispersed within a hydrophobic solvent, wherein: the core of the core-shell particles comprises an aqueous solution; the shell of the core-shell particles comprises a non-halogenated hydrophobic nanoparticle in contact with a silicon-based polymer; a w/w ratio of the silicon-based polymer to the non-halogenated hydrophobic nanoparticle within the shell is between 3:1 and 1:3; and the hydrophobic non-halogenated nanoparticle comprises a chemically modified metal oxide nanoparticle.

In one embodiment, the metal oxide comprises nanoclay, SiO₂, TiO₂, Al₂O₃, Fe₂O₃, ZnO, and ZrO or any combination thereof.

In one embodiment, the chemical modification comprises any of (C1-C20) alkyl, (C1-C20) alkylsilane group, vinyl, epoxy, a cycloalkane, an alkene, an alkyne, an ether, a silyl group, and a siloxane group, or any combination thereof.

In one embodiment, the silicon-based polymer silicon-based polymer is represented by Formula: [SiR₁R₂—O]ₙ, wherein: n is an integer ranging from 100 to 150000; R1, R₂ or both are selected from the group comprising: hydrogen, (C1-C20) alkyl group, (C1-C20) alkoxy group, an aryl group, a cycloalkyl group, or any combination thereof.

In one embodiment, the silicon-based polymer comprises PDMS.

In one embodiment, a w/w concentration of the core-shell particle within the composition is between 30% and 90%.

In one embodiment, a w/w concentration of the silicon-based polymer within the composition is between 0.1 and 10%.

In one embodiment, a w/w concentration of the non-halogenated hydrophobic nanoparticle within the composition is between 0.1 and 20%.

In one embodiment, a w/w ratio of the aqueous solution to the hydrophobic solvent within the composition is between 0.5:1 and 1:0.5.

In one embodiment, the composition is characterized by an enhanced stability.

In one embodiment, the core-shell particle has an average diameter between 1 μm and 50 μm.

In one embodiment, the shell has a thickness of 10 nm to 500 nm.

In one embodiment, the core-shell particle is in a form of a sphere.

In one embodiment, the core-shell particle is in a form of a colloidosome.

In one embodiment, the composition is selected from the group consisting of an emulsion, a dispersion, or any combination thereof.

In one embodiment, the emulsion is selected from water in oil Pickering emulsion, and oil in water Pickering emulsion.

In one embodiment, the hydrophobic solvent is selected from an aromatic hydrocarbon, an aliphatic hydrocarbon or both.

In one embodiment, the aromatic hydrocarbon is selected from the group consisting of toluene, ethylbenzene, xylene, chlorobenzene, styrene, dichlorobenzene, nitrobenzene, trimethylbenzene, trichlorobenzene or any combination thereof.

In another aspect, there is an article comprising: a substrate in contact with a coating comprising a plurality of dry core-shell particles wherein the core of the dry core-shell particles is void, and wherein the shell of the dry core-shell particles comprises the non-halogenated hydrophobic nanoparticle in contact with the silicon-based polymer.

In one embodiment, the coating comprises a plurality of dry core-shell particles bound to the substrate.

In one embodiment, the metal oxide comprises nanoclay, SiO₂, TiO₂, Al₂O₃, Fe₂O₃, ZnO, and ZrO or any combination thereof.

In one embodiment, the chemical modification comprises any of (C1-C20) alkyl, (C1-C20) alkylsilane group, vinyl, epoxy, a cycloalkane, an alkene, an alkyne, an ether, a silyl group, and a siloxane group, or any combination thereof.

In one embodiment, silicon-based polymer is represented by Formula: [SiR₁R₂—O]ₙ, wherein: n is an integer ranging from 100 to 150000; R1, R2 or both are selected from the group comprising: hydrogen, (C1-C20) alkyl group, (C1-C20) alkoxy group, an aryl group, a cycloalkyl group, or any combination thereof.

In one embodiment, the silicon-based polymer comprises PDMS.

In one embodiment, a shape of the plurality of dry core-shell particles is in a form of a hollow sphere, a crater, a quasi-sphere, a quasi-elliptical sphere, or any combination thereof.

In one embodiment, the coating is in a form of a coating layer.

In one embodiment, the substrate is selected from, a polymeric substrate, a glass substrate, a metallic substrate, a fiber, a paper substrate, a brick wall, a sponge, a textile, a woven fabric, a non-woven fabric, or wood.

In one embodiment, the polymeric substrate comprises polyolefin.

In one embodiment, the coating is an anti-microbial coating.

In one embodiment, the anti-microbial coating is capable of reducing at least one of (i) biofilm formation and (ii) microbial load by at least 10%, compared to a control.

In one embodiment, the coating is characterized by an average thickness of 100 nm to 500 μm.

In one embodiment, the coating is characterized by a water contact angle (WCA) of at least 130°.

In one embodiment, the coating is characterized by a roll-off (RA) angle between 0 and 10°.

In one embodiment, the article is stable at a temperature range of −100° C. to 200° C.

In one embodiment, the article is characterized by a transparency of 30% to 100%.

In one embodiment, a surface roughness of the coating layer is less than 500 nm.

In another aspect, there is a method for manufacturing the article of the invention, comprising the steps of: providing the composition the invention; applying the composition on at least a portion of a substrate, thereby obtaining a layer; providing the layer under conditions appropriate for drying of the layer, thereby obtaining the article.

In one embodiment, conditions appropriate for drying comprise exposing the layer to any one of vacuum, thermal irradiation, microwave irradiation, infra-red irradiation, and UV-visible irradiation, or any combination thereof.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A (1A1-1A3) and 1B (1B1-1B3) are micrographs representing cryo-SEM images of: Toluene-water (w/o ratio, 60:40) with hydrophobic silica (1 wt. %) and PDMS (1%) Pickering emulsion (FIGS. 1A(1-3)) and of Xylene-water (w/o ratio, 50:50) with hydrophobic silica (1 wt. %) and PDMS (1%) Pickering emulsion (FIGS. 1B(1-3)).

FIGS. 2A (2A1-2A2) and 2B (2B1-2B2) are micrographs representing confocal microscopy images of: Toluene-water (w/o ratio, 60:40) with hydrophobic silica (1 wt. %) and PDMS (1%) Pickering emulsion (FIGS. 2A(1-2)) and of Xylene-water (w/o ratio, 50:50) with hydrophobic silica (1 wt. %) and PDMS (1%) Pickering emulsion (FIGS. 2B(1-2)). The hydrophobic phase was stained with Nile red (excited at 552 nm).

FIG. 3 is a graph representing droplet size distribution of the emulsions (Toluene-water and Xylene-water) measured during 14 days of storage at room temperature.

FIG. 4 is a schematic illustration of the emulsion's preparation and the disposition of the compound.

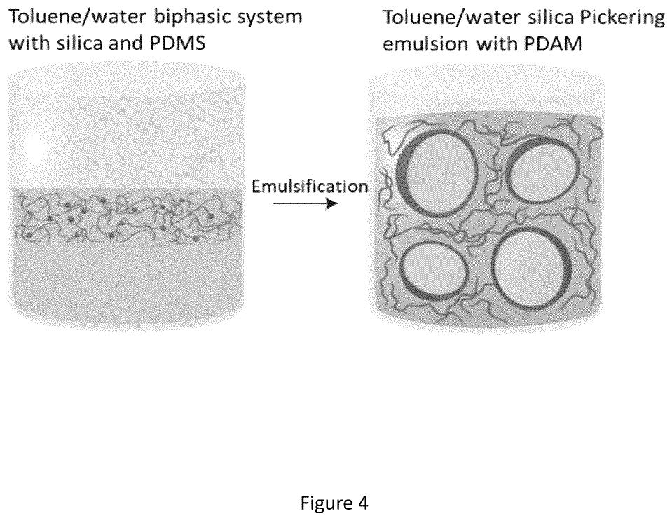

FIGS. 5A-5B are micrographs representing SEM images of: Toluene-water (w/o ratio, 60:40) with hydrophobic silica (1 wt. %) and PDMS (1%) Pickering emulsion (5A) and of Xylene-water (w/o ratio, 50:50) with hydrophobic silica (1 wt. %) and PDMS (1%) Pickering emulsion (5B).

FIGS. 6A-6B are micrographs representing AFM images of: Toluene-water (w/o ratio, 60:40) with hydrophobic silica (1 wt. %) and PDMS (1%) Pickering emulsion (6A) and of Xylene-water (w/o ratio, 50:50) with hydrophobic silica (1 wt. %) and PDMS (1%) Pickering emulsion (6B).

FIGS. 7A-7B are images representing contact angle and roll of angle measurements of PP surfaces coating with Pickering emulsion (7A) of Toluene-water (w/o ratio, 60:40), hydrophobic silica (1 wt. %) with PDMS; and (7B) Xylene-water (w/o ratio, 50:50) hydrophobic silica (1 wt. %) with PDMS.

FIGS. 8A-8B are micrographs representing SEM images of bacterial loading of: (A) uncoated PP substrate, and (B) of PP substrate coated with Pickering emulsion containing Toluene-water (w/o ratio, 60:40), hydrophobic silica (1 wt. %) and PDMS (1%).

FIG. 9 is a bar graph representing bacterial load after about 24 hours on an uncoated PP substrate versus a PP substrate coated with a Pickering emulsion containing Xylene-water (w/o ratio, 50:50) with hydrophobic silica (1 wt. %) and PDMS (1%).

### DETAILED DESCRIPTION OF THE INVENTION

According to some embodiments, the present invention provides a composition comprising a plurality of core-shell particles. In some embodiments, the composition comprises a water-in-oil (W/O) Pickering emulsion. In some embodiments, the composition comprises an oil-in-water (O/W) Pickering emulsion. The emulsions according to the present invention comprises particles comprising a shell of hydrophobic nanoparticles in contact with a silicon-based polymer and a core comprising an aqueous solution. In some embodiments, the emulsions are used as active coatings.

According to some embodiments, the present invention provides a composition comprising a core-shell particle dispersed within a hydrophobic solvent, wherein a core of the core-shell particles comprises an aqueous solution; a shell of the core-shell particles comprises a hydrophobic nanoparticle in contact with a silicon-based polymer, wherein the a hydrophobic nanoparticle is a non-fluorinated (or a non-halogenated nanoparticle) and a w/w ratio of the silicon-based polymer to the non-fluorinated hydrophobic nanoparticle within the shell is between 3:1 and 1:3.

In some embodiments, the shell is a single layer shell. In some embodiments, the particles are in the interface between a major phase and a minor phase, wherein the composition (e.g., emulsion or dispersion) is stabilized by the hydrophobic nanoparticles. In some embodiments, the particle comprises a silicon-based polymer. In some embodiments, a w/w ratio of the silicon-based polymer to the non-fluorinated nanoparticle within the shell is between 3:1 and 1:3. In some embodiments, the particles are characterized by a core encapsulating an aqueous solution.

According to some embodiments, the present invention provides an article comprising a substrate, and a plurality of particles comprising a core and a shell, wherein the plurality of particles are in the form of a coating layer on the substrate. In some embodiments, the shell of the particles comprises a silicon-based polymer in contact with the hydrophobic nanoparticle.

In some embodiments, the coating layer is an active coating (e.g., characterized by reduced microbial load, and/or comprising a biologically active agent encapsulated within the coating). In some embodiments, the coating layer on the article results from the emulsion described herein, after application on a surface and drying. In some embodiments, the article comprising the coating layer is characterized by anti-microbial properties.

In some embodiments, the coating is stable (e.g., maintains at least 90% of its surface roughness, structural form, or chemical composition) upon mechanical abrasion.

### The Composition

In one aspect of the invention, there is a composition comprising an emulsion or dispersion. In some embodiments, the emulsion is an O/O Pickering emulsion. In some embodiments, the emulsion is a W/O Pickering emulsion. In some embodiments, the emulsion is an O/W Pickering emulsion.

In some embodiments, the composition comprises an emulsion or dispersion, comprising a plurality of particles. In some embodiments, the particles are in the form of droplets. In some embodiments, the particles are in the form of core-shell particles (e.g., each particle comprises a shell and a core).

As used herein, the term “Pickering emulsion” refers to an emulsion that utilizes solid particles as a stabilizer to stabilize droplets of a substance, in a dispersed phase in the form of droplets dispersed throughout a continuous phase.

As used herein, the term “emulsion” refers to a combination of at least two fluids, where one of the fluids is present in the form of droplets in the other fluid. The term “emulsion” includes microemulsions.

As used herein, the term “fluid” refers to a substance that tends to flow and to conform to the outline of its container, i.e., a liquid, a gas, a viscoelastic fluid, etc. Typically, fluids are materials that are unable to withstand a static shear stress, and when a shear stress is applied, the fluid experiences a continuing and permanent distortion. The fluid may have any suitable viscosity that permits flow. If two or more fluids are present, each fluid may be independently selected among essentially any fluids (liquids, gases, and the like) by those of ordinary skill in the art, by considering the relationship between the fluids. In some cases, the droplets may be contained within a carrier fluid, e.g., a liquid.

In another aspect of the invention, there is composition, comprising a core-shell particle dispersed within a hydrophobic solvent, wherein a core of the core-shell particles comprises an aqueous solution; a shell of the core-shell particles comprises a non-fluorinated nanoparticle in contact with a silicon-based polymer, and a w/w ratio of the silicon-based polymer to the non-fluorinated nanoparticle within the shell is between 3:1 and 1:3. In some embodiments, the composition of the invention comprises a hydrophobic solvent and a plurality of the core-shell particles of the invention.

In some embodiments, the composition comprises a hydrophobic solvent, selected from an aliphatic organic solvent and an aromatic organic solvent or any combination thereof. In some embodiments, the hydrophobic solvent is substantially devoid of a polar organic solvent. In some embodiments, the hydrophobic solvent is substantially devoid of a halogenated solvent.

In some embodiments, the hydrophobic solvent is substantially non-polar. In some embodiments, the hydrophobic solvent is water immiscible. In some embodiments, the hydrophobic solvent is characterized by water solubility of less than 1 g/100 L, less than 0.1 g/100 L, less than 0.01 g/100 L, less than 0.001 g/100 L, including any range therebetween.

In some embodiments, the hydrophobic solvent is characterized by water solubility of between 0.0001 and 0.1 g/100 L, between 0.0001 and 0.001 g/100 L, between 0.001 and 0.005 g/100 L, between 0.005 and 0.01 g/100 L, between 0.01 and 0.05 g/100 L, between 0.05 and 0.1 g/100 L, including any range therebetween.

In some embodiments, the hydrophobic solvent is characterized by a dipole moment of less than 1.8, less than 1.5, less than 1.3, less than 1.0, less than 0.8, less than 0.6, less than 0.4, less than 0.2, less than 0.1, including any range therebetween.

In some embodiments, the hydrophobic solvent is characterized by a dipole moment of between 0 and 0.5, between 0.5 and 1, between 1 and 1.5, including any range therebetween.

In some embodiments, the hydrophobic solvent is characterized by a dipole moment and by water solubility as described hereinabove.

In some embodiments, the hydrophobic solvent is devoid of additional non-hydrophobic solvents. In some embodiments, the fluid consists essentially of the hydrophobic solvent. In some embodiments, the hydrophobic solvent refers to any known hydrophobic solvent being utilized in a chemical and/or pharmaceutical industry. In some embodiments, the hydrophobic solvent is substantially devoid of an additional liquid. In some embodiments, the hydrophobic solvent comprises a plurality of hydrophobic solvents (e.g., a mixture of solvents).

In some embodiments, the hydrophobic solvent is selected from an aromatic hydrocarbon, an aliphatic hydrocarbon or both.

Non-limiting examples of hydrophobic solvents (e.g., aliphatic hydrocarbons) include but are not limited to: pentane, hexane, cyclohexane, octane, heptane, or any combination thereof. Other aliphatic hydrocarbon solvents are well known in the art such as ethyl ether, methyl ethyl ketone (MEK), methylisobutylketone, dichloromethane, chloroform, aliphatic esters (such as ethyl acetate).

Non-limiting examples of hydrophobic solvents (e.g., aromatic hydrocarbons) include but are not limited to: toluene, ethylbenzene, xylene, chlorobenzene, styrene, dichlorobenzene, nitrobenzene, trimethylbenzene, trichlorobenzene or any combination thereof. In some embodiments, the composition of the invention is substantially devoid of chlorinated solvents, fluorinated solvents, or both.

In some embodiments, the core-shell particle of the invention comprises an aqueous core and an amphiphilic shell. In some embodiments, the core-shell particle is in a form of a colloidosome.

In some embodiments, the core-shell particle has a spherical geometry or shape. In some embodiments, the core-shell particle has an inflated or a deflated shape. In some embodiments, a plurality of core-shell particles is devoid of any characteristic geometry or shape. In some embodiments, the core-shell particle has a spherical shape, a quasi-spherical shape, a quasi-elliptical sphere, a deflated shape, a concave shape, an irregular shape, or any combination thereof.

In some embodiments, the plurality of core-shell particles are substantially spherically shaped, wherein substantially is as described herein. In some embodiments, the plurality of core-shell particles are substantially elliptically shaped, wherein substantially is as described herein. In some embodiments, the core-shell particle (e.g., a dry particle) is in a form of a hollow sphere. One skilled in the art will appreciate that the exact shape of each of the plurality of core-shell particles may differ from one particle to another. Moreover, the exact shape of the core-shell particle may be derived from any of the geometric forms listed above, so that the shape of the particle does not perfectly fits to a specific geometrical form. One skilled in the art will appreciate that the exact shape of the core-shell particle may have substantial deviations (such as at least 5%, at least 10%, at least 20% deviation) from a specific geometrical shape (e.g., a sphere or an ellipse).

In some embodiments, the core-shell particle have a diameter between 0.5 μm and 500 μm, 1 μm to 100 μm, 5 μm to 100 μm, 10 μm to 100 μm, 50 μm to 100 μm, 1 μm to 80 μm, 10 μm to 80 μm, 50 μm to 80 μm, 10 μm to 50 μm, 80 μm to 100 μm, 100 μm to 200 μm, 200 μm to 300 μm, 300 μm to 400 μm, 400 μm to 500 μm, 1 μm to 10 μm, 5 μm to 10 μm, 1 μm to 50 μm, 10 μm to 50 μm, 5 μm to 50 μm, or 1 μm to 5 μm, including any range or value therebetween.

In some embodiments, the diameter of the core-shell particle described herein, represents an average diameter. In some embodiments, the size of the core-shell particle described herein represents an average or median size of a plurality of particles. In some embodiments, the average, or the median size of at least e.g., 10%, 20%, 30%, 40%, 50%, 60%, 70%, 80%, 90%, or 95% of the particles, ranges from: 5 μm to 50 μm, 1 μm to 50 μm, 5 μm to 10 μm, including any range therebetween. In some embodiments, the diameter of the core-shell particle described herein, is a dry diameter (i.e., a diameter of isolated dried particles). In some embodiments, a plurality of the core-shell particles has a uniform size. By “uniform” or “homogenous” it is meant to refer to size distribution that varies within a range of less than e.g., +60%, +50%, +40%, +30%, +20%, or +10%, including any value therebetween.

In some embodiments, the core-shell particle is in a form of a droplet.

In some embodiments, a diameter of the droplet is between 1 μm to 100 μm, 5 μm to 100 μm, 10 μm to 100 μm, 50 μm to 100 μm, 1 μm to 80 μm, 10 μm to 80 μm, 50 μm to 80 μm, 1 μm to 10 μm, 5 μm to 10 μm, 1 μm to 50 μm, 10 μm to 50 μm, 5 μm to 50 μm, or 1 μm to 5 μm, including any range therebetween.

As used herein, the term “droplet” refers to an isolated portion of a first fluid that is surrounded by a second fluid. It is to be noted that a droplet is not necessarily spherical; but may assume other shapes as well, for example, depending on the external environment. In some embodiments, the droplet has a minimum cross-sectional dimension that is substantially equal to the largest dimension of the channel perpendicular to fluid flow in which the droplet is located. In some cases, the droplet may be a vesicle, such as a liposome, a colloidosome, or a polymerosome. The fluidic droplets may have any shape and/or size. Typically, monodisperse droplets are of substantially the same size. The shape and/or size of the fluidic droplets can be determined, for example, by measuring the average diameter or other characteristic dimension of the droplets. The “average diameter” of a plurality or series of droplets is the arithmetic average of the average diameters of each of the droplets. Those of ordinary skill in the art will be able to determine the average diameter (or other characteristic dimension) of a plurality or series of droplets, for example, using laser light scattering, microscopic examination, or other known techniques. The average diameter of a single droplet, in a non-spherical droplet, is the diameter of a perfect sphere having the same volume as the non-spherical droplet.

In some embodiments, the average diameter of a droplet (and/or of a plurality or series of droplets) is, 5 μm to 100 μm, 5 μm to 50 μm, 1 μm to 50 μm, including any range therebetween. In some embodiments, the average diameter of a droplet is a wet diameter (i.e., a particle dimeter within a solution).

In some embodiments, the core-shell particle of the invention is a droplet. In some embodiments, the core-shell particle of the invention is a colloidosome.

In some embodiments, the core-shell particle comprises between 0.1% and 10%, between 0.1% and 0.5%, between 0.5% and 1%, between 1% and 1.5%, between 1.5% and 2%, between 2% and 3%, between 3% and 5%, between 5% and 10% (w/w) of the hydrophobic nanoparticles including any range therebetween, wherein the core-shell particle is a droplet (e.g., comprises an aqueous core).

In some embodiments, the core-shell particle comprises between 1% and 90%, between 10% and 99%, between 10% and 20%, between 20% and 30%, between 30% and 50%, between 50% and 60%, between 60% and 70%, between 70% and 80%, between 80% and 90%, between 90% and 99% (w/w) of the hydrophobic nanoparticles including any range therebetween, wherein the core-shell particle is a dry core-shell particle (e.g. a hollow-sphere, wherein the particle's core is substantially devoid of liquid).

As used herein, the term “hydrophobic nanoparticle” and the term “non-fluorinated hydrophobic nanoparticle” or the term “non-fluorinated nanoparticle” are used interchangeably. Furthermore, as used herein, the term “non-halogenated nanoparticle” and the term “non-fluorinated nanoparticle” are used interchangeably. One skilled in the art will appreciate, that the hydrophobic nanoparticle disclosed herein refers to a chemically modified particle, wherein the chemical modification is devoid of fluorine atoms (also used herein as non-fluorinated, or non-halogenated nanoparticle). Thus, the hydrophobic or non-fluorinated nanoparticle of the invention may relate to a chemically modified particle, wherein the chemical modification comprises any of halogenated, halogenated, and alkylated particle (such as by halo-dimethylsilane) or a haloalkylated particle, wherein the chemical modification is substantially devoid of fluorine atoms. To this end, the hydrophobic nanoparticle or the non-fluorinated nanoparticle disclosed herein, encompasses inter alia a metal oxide particle modified by alkyl-silyl, and/or by alkyl-halosilyl, wherein halosilyl contains halogen selected from Cl, Br, and I.

In some embodiments, the core of the dry core-shell particle is void. In some embodiments, the core of the core-shell particle (e.g., dry or droplet form) is substantially devoid of the hydrophobic nanoparticle and/or of the silicon-based polymer. In some embodiments, a stable emulsion of the invention comprises substantially hollow-sphere core-shell particles. In some embodiments, a stable emulsion of the invention comprises between 0.1 and 10% by weight of the hollow-sphere (or dry) core-shell particles including any range therebetween.

In some embodiments, the core-shell particle comprises between 0.1% and 10%, between 0.1% and 0.5%, between 0.5% and 1%, between 1% and 1.5%, between 1.5% and 2%, between 2% and 3%, between 3% and 5%, between 5% and 10% (w/w) of the silicon-based polymer including any range therebetween, wherein the core-shell particle is a droplet (e.g., comprises an aqueous core).

In some embodiments, the core-shell particle comprises between 1% and 90%, between 10% and 99%, between 10% and 20%, between 20% and 30%, between 30% and 50%, between 50% and 60%, between 60% and 70%, between 70% and 80%, between 80% and 90%, between 90% and 99% (w/w) of the silicon-based polymer including any range therebetween, wherein the core-shell particle is a dry core-shell particle (e.g. a hollow-sphere, wherein the particle's core is substantially devoid of liquid).

In some embodiments, the dry core-shell particle of the invention comprises the shell as described herein, and an empty core, being substantially devoid of a liquid (e.g., aqueous solution and/or solvent). In some embodiments, the dry core-shell particle of the invention is substantially devoid of an aqueous solution and/or solvent (e.g., the hydrophobic solvent of the invention).

In some embodiments, the composition of the invention comprises an emulsion or dispersion, comprising a plurality of core-shell particles, having a diameter of 1 μm to 50 μm, the particles comprising a shell having a thickness of 5 nm to 500 nm, and comprising inorganic hydrophobic nanoparticles in contact with the silicon-based polymer. In some embodiments, the composition of the invention is an emulsion or dispersion, comprising a plurality of core-shell particles (e.g., droplets), wherein the core-shell particles consist essentially of an aqueous core; and of inorganic hydrophobic nanoparticles in contact with the silicon-based polymer forming or defining the shell.

In some embodiments, the hydrophobic nanoparticles are bound or adhered to the silicon-based polymer. In some embodiments, the hydrophobic nanoparticles are mixed with the silicon-based polymer, thereby forming the shell. In some embodiments, bound is via non-covalent bonds or interactions. In some embodiments, bound is adsorption (physisorption). In some embodiments, bound is via non-ionic physical bond or interaction.

In some embodiments, the hydrophobic nanoparticles are embedded into the silicon-based polymer. In some embodiments, the hydrophobic nanoparticles are bound or held together by the silicon-based polymer. In some embodiments, the hydrophobic nanoparticles are immobilized into the silicon-based polymer. In some embodiments, the silicon-based polymer reduces the surface tension of the aqueous core.

In some embodiments, the shell is in a form of a layer. In some embodiments, the shell is in a form of a uniform layer. In some embodiments, the shell is in a form of a homogenous layer. In some embodiments, the hydrophobic nanoparticles are homogenously distributed within the entire volume of the shell.

In some embodiments, a w/w ratio of the silicon-based polymer to the hydrophobic nanoparticle within the shell is between 3:1 and 1:3, between 3:1 and 2:1, between 2:1 and 1:1, between 1:1 and 1:2, between 1:2 and 1:3, including any range or value therebetween.

In some embodiments, a w/w concentration of the silicon-based polymer within the shell is between 30 to 70%, between 30 to 40%, between 40 to 50%, between 50 to 60%, between 60 to 70%, including any range or value therebetween.

In some embodiments, the silicon-based polymer and the non-fluorinated nanoparticle comprise up to 80%, up to 85%, up to 90%, up to 92%, up to 95%, up to 97%, up to 99%, up to 98%, up to 96% w/w of the particle shell. In some embodiments, the silicon-based polymer and the non-fluorinated nanoparticle comprise up to 80%, up to 85%, up to 90%, up to 92%, up to 95%, up to 97%, up to 99%, up to 98%, up to 96% w/w of the particle shell.

In some embodiments, the shell comprises an inner portion facing the core (e.g., particle's core) and an outer portion facing the hydrophobic solvent. In some embodiments, the shell forms an interphase layer between the hydrophilic (e.g., aqueous) core and the hydrophobic solvent (e.g., major phase). In some embodiments, the composition is a w/o emulsion, wherein the aqueous minor phase forms a core, and the interphase forms a shell of the core-shell particle of the invention.

In some embodiments, the inner portion is in contact with the core. In some embodiments, the inner portion is bound to the core. In some embodiments, the shell stabilizes the core. In some embodiments, the shell encapsulates the core.

In some embodiments, the shell is a layered shell. In some embodiments, the inner portion forms a first layer, and the outer portion forms an additional layer. In some embodiments, the inner portion of the shell comprises the silicon-based polymer and the outer portion comprises the hydrophobic nanoparticle. In some embodiments, the shell comprise an intermediate layer comprising the non-fluorinated nanoparticle in contact with the silicon-based polymer, wherein the intermediate is substantially homogenous.

In some embodiments, the shell has a thickness in the range of 5 nm to 50 nm, 15 nm to 50 nm, 30 nm to 50 nm, 1 nm to 50 nm, 2 nm to 50 nm, 5 μm to 10 nm, 10 nm to 50 nm, 5 nm to 30 nm, 15 nm to 30 nm, 1 nm to 20 nm, 2 nm to 20 nm, 5 nm to 20 nm, or 10 nm to 20 nm, 20 nm to 30 nm, 30 nm to 40 nm, 40 nm to 80 nm, 80 nm to 100 nm, 100 nm to 200 nm, 200 nm to 300 nm, 300 nm to 500 nm, including any range therebetween. In some embodiments, the shell thickness is quantified using scanning electron microscopy (SEM).

In some embodiments, the shell comprises between 30 to 70%, between 30 to 40%, between 40 to 50%, between 50 to 60%, between 60 to 70%, including any range or value therebetween (w/w) of the hydrophobic nanoparticles.

In some embodiments, the shell is stabilized by the silicon-based polymer.

In some embodiments, the polymer of the invention (e.g., silicon-based polymer) is soluble in an organic solvent (such as the hydrophobic solvent of the invention), wherein soluble is at least 10 g/L. In some embodiments, the silicon-based polymer is soluble in an aromatic solvent. In some embodiments, the silicon-based polymer is soluble in toluene and/or xylene.

In some embodiments, the silicon-based polymer (e.g., PDMS) has an affinity to the hydrophobic nanoparticle. In some embodiments, the silicon-based polymer is capable of binding (e.g., non-covalent interactions) or adhesion to the hydrophobic nanoparticle.

In some embodiments, the silicon-based polymer is a polysiloxane. In some embodiments, the silicon-based polymer comprises a plurality of polymers. In some embodiments, the silicon-based polymer comprises a plurality of polysiloxanes.

In some embodiments, the silicon-based polymer is represented by Formula 1: [—SiR₁R₂—O—]ₙ, or by Formula 1A: R₃—[—SiR₁R₂—O—]ₙ—R₃; wherein:
R₁ and R₂ each independently is selected from the group comprising hydrogen, an alkyl group, an alkoxy group, a thioalkoxy group, an aryl group, a fused ring, an alkaryl group, a heteroaryl group, a cycloalkyl group, an aryloxy group, a thioaryloxy group, an ether group, and a halo group or any combination thereof;
each R₃ is independently selected from the group comprising: hydrogen, a halo group, an alkoxy group, a hydroxy group, and a bond; and n is an integer ranging from 10 to 150000, and wherein at least one of R1 and R2 is not hydrogen.

In some embodiments, n is an integer ranging from 10 to 50, from 50 to 100, from 100 to 120000, 100 to 100000, 100 to 90000, 100 to 70000, 100 to 50000, 100 to 40000, 100 to 30000, 100 to 30000, 100 to 10000, 100 to 9000, 100 to 8000, 100 to 5000, 100 to 4000, 100 to 3000, 100 to 2000, 100 to 200, 200 to 500, 500 to 1000, 200 to 150000, 500 to 150000100 to 150000, 1000 to 150000, 2000 to 150000, 5000 to 150000, 10000 to 150000, 500 to 100000, 500 to 90000, 500 to 70000, 500 to 50000, 500 to 40000, 500 to 30000, 500 to 30000, 500 to 10000, 500 to 9000, 500 to 8000, or 500 to 5000, including any range therebetween.

In some embodiments, R₁, R₂ or both are each independently selected from the group comprising: hydrogen, and a C1-C20 alkyl group or both, and wherein at least one of R1 and R2 is not hydrogen. In some embodiments, R₁, and R₂ are C1-C20 alkyls. In some embodiments, C1-20 alkyl comprises between 1 and 20, between 1 and 3, between 3 and 5, between 5 and 10, between 10 and 15, between 15 and 20 carbon atoms (or methylene groups) including any range therebetween. In some embodiments, C1-20 alkyl comprises an alkane, alkene, alkyne, or a combination thereof. In some embodiments, C1-20 alkyl is a liner alkyl. In some embodiments, C1-20 alkyl is a linear alkane.

In some embodiments, R₁, R₂ or both are selected from the group comprising: hydrogen, and a lower alkyl group or both.

As used herein, the term “alkyl” alone or in combination refers to a straight, branched, or cyclic chain containing at least one carbon atom and no double or triple bonds between carbon atoms. As used herein, the term “lower alkyl” refers to a C1-C₆ alkyl. A “lower alkyl” can be designated as “C₁-C₄ alkyl” or similar designations. By way of example only, “C₁-C₄ alkyl” indicates an alkyl having one, two, three, or four carbon atoms, i.e., the alkyl is selected from among methyl, ethyl, propyl, iso-propyl, n-butyl, iso-butyl, sec-butyl, and t-butyl. Thus C₁-C₄ includes C₁-C₂ and C₁-C₃alkyl. Alkyls can be substituted or unsubstituted. Alkyls include, but are not limited to, methyl, ethyl, propyl, isopropyl, butyl, isobutyl, tertiary butyl, pentyl, hexyl, ethenyl, propenyl, butenyl, cyclopropyl, cyclobutyl, cyclopentyl, and cyclohexyl, each of which optionally are substituted.

In some embodiments, C1-20 alkyl and/or the lower alkyl is substituted by a substituent selected from halo, hydroxy, amino, cyano, nitro, alkylamido, acyl, or a combination thereof.

In some embodiments, R₁, R₂ or both are selected from hydrogen, methyl, ethyl, butyl, isobutyl, or a combination thereof.

In some embodiments, the silicon-based polymer is or comprises an alkylated siloxane polymer, including any mixture or any copolymer thereof. In some embodiments, the silicon-based polymer comprises poly(dimethyl siloxane) (PDMS) including any mixture or any copolymer thereof. In some embodiments, the silicon-based polymer comprises PDMS elastomer. In some embodiments, the silicon-based polymer consists essentially of PDMS.

In some embodiments, the silicon-based polymer has an average molecular weight ranging from 1500 g/mol to 150000 g/mol. In some embodiments, the silicon-based polymer has an average molecular weight ranging from 1700 g/mol to 150000 g/mol, 1900 g/mol to 150000 g/mol, 2000 g/mol to 150000 g/mol, 2500 g/mol to 150000 g/mol, 4000 g/mol to 150000 g/mol, 5000 g/mol to 150000 g/mol, 7000 g/mol to 150000 g/mol, 10000 g/mol to 150000 g/mol, 20000 g/mol to 150000 g/mol, 50000 g/mol to 150000 g/mol, 70000 g/mol to 150000 g/mol, 100000 g/mol to 150000 g/mol, 1500 g/mol to 100000 g/mol, 1500 g/mol to 80000 g/mol, 1500 g/mol to 50000 g/mol, 1500 g/mol to 20000 g/mol, 1500 g/mol to 10000 g/mol, 2000 g/mol to 100000 g/mol, 2000 g/mol to 80000 g/mol, 2000 g/mol to 50000 g/mol, 2000 g/mol to 20000 g/mol, 2000 g/mol to 10000 g/mol, 5000 g/mol to 100000 g/mol, 5000 g/mol to 80000 g/mol, 5000 g/mol to 50000 g/mol, 5000 g/mol to 20000 g/mol, or 5000 g/mol to 10000 g/mol, including any range therebetween.

As used herein throughout, the term “polymer” describes an organic substance composed of a plurality of repeating structural units (backbone units) covalently connected to one another.

In some embodiments, the silicon-based polymer is substantially devoid of silicon oil. In some embodiments, the silicon-based polymer is substantially devoid of mineral oil. In some embodiments, the silicon-based polymer is substantially devoid of fluorinated polymers, such as fluorinated polysiloxane, Teflon, etc.

In some embodiments, the particle shell comprises a plurality of nanoparticles. In some embodiments, the nanoparticles are hydrophobic. In some embodiments, the outer surface of the nanoparticles is hydrophobic. In some embodiments, the nanoparticles comprise inorganic particles. In some embodiments, the hydrophobic nanoparticles comprise chemically modified inorganic particles. In some embodiments, the hydrophobic nanoparticles comprise inorganic particles having a chemical modification (e.g., a hydrophobic group attached thereto).

In some embodiments, the non-fluorinated nanoparticle comprise a metal oxide. In some embodiments, the hydrophobic nanoparticles comprise a metal oxide as a core and a hydrophobic coating or shell bound thereto. In some embodiments, the hydrophobic nanoparticles are metal oxide-based particles. In some embodiments, the hydrophobic nanoparticles are selected from the group consisting of silica, titanium oxide, clay, and any combination thereof.

In some embodiments, the non-fluorinated nanoparticle comprises alkyl-functionalized, silane-functionalized, alkoxy silane-functionalized, alkyl silane-functionalized metal oxide nanoparticle, or any combination thereof. In some embodiments, the non-fluorinated nanoparticle comprises a functionalized (or chemically modified) metal oxide nanoparticle. In some embodiments, functionalized comprises a chemical moiety (or a substituent) covalently bound to the metal oxide nanoparticle. In some embodiments, the chemical moiety (or a substituent) comprises any of (C1-C20) alkyl, (C1-C20) alkylsilane group, vinyl, epoxy, a cycloalkane, an alkene, an alkyne, an ether, a silyl group, and a siloxane group, or any combination thereof. In some embodiments, the chemical moiety (or a substituent) comprises any of (C1-C20)alkyl, (C1-C20)haloalkyl, halo, (C1-C20) haloalkylsilyl, (C1-C20)alkylsilyl group, vinyl, epoxy, a cycloalkane, an alkene, an alkyne, an ether, an alkyl-halosilyl group, alkyl-hydroxysilyl group, haloalkyl-hydroxysilyl group, halo-hydroxysilyl group and a siloxane group, or any combination thereof, and wherein halo is selected from Cl, Br, and I.

In some embodiments, the non-fluorinated nanoparticle is substantially devoid of halo groups (such as fluoro moieties). In some embodiments, the non-fluorinated nanoparticle is substantially devoid of a halo-alkyl moiety.

In some embodiments, (C1-C20) alkylsilyl comprises a Si bound to at least one C1-C20 alkyl (e.g., directly or via an oxygen atom), wherein C1-C20 alkyl comprises between 1 and 20, between 1 and 3, between 3 and 5, between 5 and 7, between 7 and 10, between 10 and 15, between 15 and 20 carbon atoms, including any range between. In some embodiments, the alkyl group comprises between 1 and 20, between 1 and 3, between 3 and 5, between 5 and 7, between 7 and 10, between 10 and 15, between 15 and 20 carbon atoms, including any range between. In some embodiments, the (C1-C20) alkylsilyl group comprises Si bound to 1, 2, or 3 C1-C20 alkyl, and wherein Si is further covalently bound to an O atom of the metal oxide particle.

In some embodiments, the hydrophobic nanoparticle comprises an alkyl silane group, or an alkyl halosilane. In some embodiments, the alkyl silane group and/or the alkyl halosilane comprises between 1 and 20, between 1 and 3, between 3 and 5, between 5 and 7, between 7 and 10, between 10 and 15, between 15 and 20 carbon atoms, including any range between. In some embodiments, the alkyl group comprises between 1 and 20, between 1 and 3, between 3 and 5, between 5 and 7, between 7 and 10, between 10 and 15, between 15 and 20 carbon atoms, including any range between. In some embodiments, the alkyl halosilane further comprises one or more halogen atoms, wherein halogen atoms are devoid of fluorine atoms.

In some embodiments, the (C1-C20) haloalkylsilyl group comprises a Si atom bound to at least one C1-C20 haloalkyl (e.g. directly or via an oxygen atom), wherein C1-C20 haloalkyl comprises between 1 and 20, between 1 and 3, between 3 and 5, between 5 and 7, between 7 and 10, between 10 and 15, between 15 and 20 carbon atoms, including any range between; and further comprises between 1 and 20, between 1 and 3, between 3 and 5, between 5 and 7, between 7 and 10, between 1 and 8, between 1 and 10, between 10 and 15, between 15 and 20 halogen atoms including any range between (e.g. Br, Cl, F or any combination thereof).

In some embodiments, the (C1-C20) haloalkylsilyl group comprises C1-C20 alkyl bound to one or more halogen atoms as described herein, wherein the C1-C20 alkyl is selected from a linear C1-C20 alkyl and a branched C1-C20 alkyl. In some embodiments, the (C1-C20) haloalkylsilyl group comprises Si bound to 1, 2, or 3 C1-C20 haloalkyl (or to a combination of halogen atoms(s) and alkyl(s)), and wherein Si is further covalently bound to an O atom of the metal oxide particle.

In some embodiments, the alkyl-halosilyl group comprises a Si atom bound to at least one C1-C20 alkyl (e.g., directly or via an oxygen atom) and to at least one halogen selected from Cl, Br, and I.

In some embodiments, any of alkyl-halosilyl group, (C1-C20) haloalkylsilyl group, and (C1-C20) alkylsilyl group comprises Si bound to one or more of the above disclosed groups, and wherein Si is optionally further bound to one or more hydroxy group(s).

In some embodiments, any of alkyl-hydroxysilyl group, haloalkyl-hydroxysilyl group, halo-hydroxysilyl group comprises Si bound to one or more of the above disclosed groups, and wherein Si is further bound to one or more hydroxy group(s).

In some embodiments, the hydrophobic nanoparticles comprise a metal oxide as a core and a hydrophobic coating or shell bound thereto, wherein the hydrophobic coating comprises an alkyl silane group comprising between 1 and carbon atoms. In some embodiments, the hydrophobic nanoparticles comprise a metal oxide as a core and a hydrophobic coating or shell bound thereto, wherein the hydrophobic coating comprises a methyl silane group attached to the metal oxide (e.g., to the oxygen atom). In some embodiments, the non-fluorinated nanoparticle comprises a metal oxide, wherein at least a part of the metal oxide (e.g., oxygen atom) is covalently bound to an alkyl silane group (e.g., methyl silane, such as dimethyl silyl group), or to an alkyl halosilane group (e.g., methyl chlorosilane, such as dimethyl chlorosilyl group, —Si(CH₃)₂Cl). In some embodiments, the non-fluorinated nanoparticle comprises a chemically modified (e.g., silylated) metal oxide (such as silica).

In some embodiments, the hydrophobic coating consists essentially of an alkyl silane group, as described herein.

Non-limiting examples of silane-hydrophobic nanoparticles include silane, methyl silane, linear alkyl silane (e.g., methyl silane), branched alkyl silane, aromatic silane, and dialkyl silane (e.g., dimethyl silane).

The term “silica” as used here refers to a structure containing at least the following the elements: silicon and oxygen. Silica may have the fundamental formula of SiO₂, or it may have another structure including SiₓO_{y} (where x and y can each independently be about 1 to 10). Additional elements including, but not limited to, carbon, nitrogen, sulfur, phosphorus, or ruthenium may also be used. Silica may be a solid particle, or it may have pores.

In some embodiments, the metal oxide comprises nanoclay, SiO₂, TiO₂, Al₂O₃, Fe₂O₃, ZnO, and ZrO or any combination thereof.

In some embodiments, the hydrophobic nanoparticles are characterized by a median (or average) particle size of 1 nm to 900 nm. In some embodiments, the derivatized nano-diamond is characterized by a median particle size of 2 nm to 600 nm, 2 nm to 550 nm, 2 nm to 520 nm, 2 nm to 500 nm, 2 nm to 480 nm, 2 nm to 450 nm, 2 nm to 400 nm, 2 nm to 350 nm, 2 nm to 300 nm, 2 nm to 250 nm, 2 nm to 200 nm, 2 nm to 150 nm, 2 nm to 100 nm, 5 nm to 600 nm, 10 nm to 600 nm, 15 nm to 600 nm, 20 nm to 600 nm, 40 nm to 600 nm, 50 nm to 600 nm, 100 nm to 600 nm, 5 nm to 500 nm, 10 nm to 500 nm, 15 nm to 500 nm, 20 nm to 500 nm, 40 nm to 600 nm, 50 nm to 500 nm, 100 nm to 500 nm, 5 nm to 400 nm, 10 nm to 400 nm, 15 nm to 400 nm, 20 nm to 400 nm, 40 nm to 400 nm, 50 nm to 400 nm, 100 nm to 400 nm, 5 nm to 50 nm, 5 nm to 40 nm, 2 nm to 50 nm, or 2 nm to 40 nm, including any range therebetween. In some embodiments, the size of at least 90% of the nanoparticles varies within a range of less than ±25%, ±20%, ±15%, ±19%, +5%, including any value therebetween.

Herein throughout, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s).

As used herein the terms “average” or “median” size refer to diameter of the particles. The term “diameter” is art-recognized and is used herein to refer to either of the physical diameter (also termed “dry diameter”) or the hydrodynamic diameter. As used herein, the “hydrodynamic diameter” refers to a size determination for the composition in solution (e.g., aqueous solution) using any technique known in the art, e.g., dynamic light scattering (DLS).

Non-limiting example of the hydrophobic particle of the invention is a chemically modified hydrophobic fumed silica, such as AEROSIL® R 972.

In some embodiments, the dry diameter of the hydrophobic particles, according to some embodiments of the invention, may be evaluated using transmission electron microscopy (TEM) or scanning electron microscopy (SEM) imaging.

The hydrophobic particle(s) can be generally shaped as a sphere, incomplete-sphere, particularly the size attached to the substrate, a rod, a cylinder, a ribbon, a sponge, and any other shape, or can be in a form of a cluster of any of these shapes, or a mixture of one or more shapes. In some embodiments, the hydrophobic particle has a spherical shape, a quasi-spherical shape, a quasi-elliptical sphere, an irregular shape, or any combination thereof.

In some embodiments, the hydrophobic particles are in the interface between a major phase and a minor phase. In some embodiments, the major phase is a continuous phase. In some embodiments, a minor phase is a dispersed phase. In some embodiments, the hydrophobic particles are in the interface of the major phase (e.g., the hydrophobic solvent described herein) and the core (e.g., aqueous core) of the core-shell particle described herein (e.g., colloidosome).

### Core

In some embodiments, the core of the core shell particle of the invention (e.g., droplet) comprises between 50% and 90%, between 50% and 70%, between 70% and 90%, between 90% and 99% (w/w) of an aqueous solution, including any range therebetween.

In some embodiments, a volume of the core of the dry core shell particle of the invention (e.g., hollow-sphere) comprises at most 99.9%, at most 97%, at most 95%, at most 90%, at most 85%, at most 80%, at most 75%, at most 70%, at most 60%, at most 50%, at most 40%, at most 30%, at most 20% v/v of a gaseous material (such as air) including any range therebetween. In some embodiments, the core of the dry core shell particle of the invention (e.g., hollow-sphere) comprises between 50 and 99.9%, between 50 and 60%, between 60 and 70%, between 70 and 80%, between 80 and 90%, between 90 and 95%, between 95 and 99.9%, v/v of a gaseous material (such as air) including any range therebetween.

In some embodiments, the particle core further comprises between 0.1% and 50%, between 0.1% and 5%, between 5% and 10%, between 10% and 20%, between 20% and 30%, between 30% and 50% (w/w) of the active agent including any range therebetween. In some embodiments, the particle core comprises between 0.1% and 50%, between 0.1% and 5%, between 5% and 10%, between 10% and 20%, between 20% and 30%, between 30% and 50% (v/v) of the active agent including any range therebetween.

In some embodiments, the active agent has a boiling temperature greater than the boiling point of the hydrophobic solvent. In some embodiments, the active agent has a boiling temperature greater than the boiling point of the aqueous solution. In some embodiments, the active agent has a boiling temperature of more than 40° C., of more than 50° C., of more than 55° C., of more than 60° C., of more than 65° C., of more than 70° C., of more than 80° C., of more than 90° C., of more than 100° C., of more than 120° C. including any range therebetween.

In some embodiments, the active agent comprises a water-soluble molecule, a lipophilic molecule, a water-insoluble molecule. In some embodiments, the water-soluble molecule has solubility in an aqueous solvent of more than 10 g/L. In some embodiments, the active agent comprises an essential oil, an herbicide, a pesticide, a fungicide, or any combination thereof.

As used herein, the term “active agent” refers to any type of material that can be encapsulated in the core and retain plant protective qualities. In some embodiments, the active agent has anti-fungal, anti-microbial, anti-insect, anti-viral, anti-mold, or plant protective qualities. In some embodiments, the active agent functions as a pesticide. In some embodiments, the active agent comprises a pesticide, an herbicide, a fragrance, a fungicide, or any combination thereof. In some embodiments, the active agent comprises a plurality of active agents, wherein the active agents are as described herein.

In some embodiments, the core of the particles encapsulates 1% to 20% (w/w) of an active agent. In some embodiments, the composition comprises 5% to 20% (w/w), 10% to 20% (w/w), 1% to 20% (w/w), 5% to 15% (w/w), 10% to 15% (w/w), 15% to 20% (w/w), 1% to 10% (w/w), 5% to 10% (w/w), or 1% to 5% (w/w), of an active agent, including any range therebetween.

### Compositions

In some embodiments, the composition of the invention is a liquid composition. In some embodiments, the composition of the invention is in a form of an emulsion (W/O or O/W emulsion), a dispersion, a suspension, and a micro emulsion or any combination thereof. In some embodiments, the composition is in a form of a Pickering emulsion, as described herein. In some embodiments, the composition comprises a water-in-oil (W/O) Pickering emulsion. In some embodiments, the composition comprises an oil-in-water (O/W) Pickering emulsion.

In some embodiments, the composition of the invention is in a form of an emulsion comprising the hydrophobic solvent (e.g., as a major phase) and a plurality of the core-shell particles of the invention dispersed therein. In some embodiments, the composition of the invention is substantially homogenous. In some embodiments, the composition of the invention is in a form of water in oil emulsion, and oil in water Pickering emulsion, comprising an active agent dissolved in the aqueous solution. In some embodiments, the core of the particles (e.g., dry particles) encapsulates an active agent.

In some embodiments, a ratio of the aqueous solution to the hydrophobic solvent within the composition is between 0.5:1 and 1:0.5 (w/w), 0.4:1 to 1:1 (w/w), 0.3:1 to 1:1 (w/w), 0.2:1 to 1:1 (w/w), 0.5:1 to 0.7:1 (w/w), 0.7:1 to 0.8:1 (w/w), 0.8:1 to 0.9:1 (w/w), 0.9:1 to 1:1 (w/w), including any range therebetween. In some embodiments, a w/w ratio between the aqueous solution and the hydrophobic solvent within the composition of the invention is about 1:1 (w/w). In some embodiments, a w/w ratio between the aqueous solution and the hydrophobic solvent within the composition of the invention is between 1:1 and 1:0.5 (w/w), between 1:1 and 1:0.9 (w/w), between 1:0.9 and 1:0.8 (w/w), between 1:0.8 and 1:0.7 (w/w), between 1:0.7 and 1:0.6 (w/w), between 1:0.6 and 1:0.5 (w/w), between 1:0.5 and 1:0.3 (w/w), between 1:0.3 and 1:0.1 (w/w), including any range therebetween.

In some embodiments, the composition of the invention (e.g., an emulsion) comprises between 30% to 90% (w/w), 30% to 40% (w/w), 40% to 50% (w/w), 50% to 55% (w/w), 55% to 60% (w/w), 60% to 70% (w/w), 70% to 80% (w/w), 80% to 90% (w/w) of the core-shell particles of the invention, including any range therebetween.

In some embodiments, a w/w concentration of the silicon-based polymer of the invention within the composition of the invention is between 0.1 and 10%, between 0.1 and 0.5%, between 0.5 and 1%, between 1 and 2%, between 2 and 3%, between 3 and 5%, between 5 and 7%, between 7 and 10%, including any range therebetween.

In some embodiments, a w/w concentration of the non-fluorinated nanoparticle of the invention within the composition of the invention is between 0.1 and 20%, between 0.1 and 0.5%, between 0.5 and 1%, between 1 and 2%, between 2 and 3%, between 3 and 5%, between 5 and 7%, between 7 and 10%, between 10 and 15%, between 15 and 17%, between 17 and 20% including any range therebetween.

In some embodiments, the composition of the invention is a liquid composition, comprising the hydrophobic nanoparticles dispersed within the hydrophobic solvent. In some embodiments, the composition is a stable composition. In some embodiments, the liquid composition is stable for at least 6 hours (h), at least 12 h, at least 24 h, at least 48 h, at least 72 h, at least 96 h, at least 10 days (d), at least one month (m), at least 6 m, at least 12 m % including any range therebetween.

As used herein the term “stable”, refers to the ability of the liquid composition to maintain substantially its intactness, such as being substantially devoid of aggregation, precipitation and/or phase separation. In some embodiments, a stable composition (e.g., the composition or the liquid composition of the invention) is substantially devoid of aggregates. In some embodiments, aggregates comprising a plurality of cores-shell particles adhered or bound to each other.

In some embodiments, the composition is for use as: a superhydrophobic coating, an anti-fungal coating, an anti-microbial coating, an anti-insect coating, an anti-viral coating, an anti-mold coating, a plant protective coating, or a pesticide coating.

### The Article

According to some embodiments, the present invention provides an article comprising (i) a substrate, and (ii) a plurality of dry core-shell particles of the invention in contact therewith. In some embodiments, the plurality of dry core-shell particles are bound to the substrate. In some embodiments, the plurality of dry core-shell particles comprise a particle of the invention. In some embodiments, the plurality of dry core-shell particles are in a form of a coating layer bound to at least one surface of the substrate. In some embodiments, the plurality of dry core-shell particles are impregnated into the substrate. In some embodiments, the plurality of dry core-shell particles are embedded into the substrate.

In some embodiments, the plurality of dry core-shell particles are stably bound to at least one surface of the substrate. In some embodiments, the article and/or the coating layer is stable (e.g., substantially retains bound to the substrate, substantially devoid of physical defects, substantially retains its shape, substantially retains its dimensions, physico-mechanical properties, etc.) upon prolonged storage at least one month (m), at least 6 m, at least 12 m, at least 1 year, at least 2 years, including any range therebetween. In some embodiments, the article and/or the coating layer is stable upon exposure to ambient conditions (including inter alia abrasion, weathering conditions, UV radiation, water, water vapors, temperature between −30 and 40° C.).

According to some embodiments, the present invention provides an article comprising a substrate in contact with a coating comprising the hydrophobic nanoparticles of the invention, and the silicon-based polymer of the invention, wherein a ratio between the hydrophobic nanoparticles and the silicon-based polymer is between 3:1 and 1:3, between 3:1 and 2:1, between 2:1 and 1:1, between 1:1 and 1:2, between 1:2 and 1:3, including any range or value therebetween.

According to some embodiments, the present invention provides an article comprising the liquid composition of the present invention. In some embodiments, the article comprises the liquid composition (e.g., emulsion) and a substrate, wherein the emulsion is in the form of a coating layer on the substrate. In some embodiments, the liquid composition (e.g., emulsion) is in the form of a coating layer in at least a portion of a surface of the substrate. In some embodiments, the liquid composition (e.g., emulsion) is evaporated resulting a layer comprising, the plurality of dry core-shell particles in a form of a coating layer on the substrate.

In some embodiments, the article comprises a substrate in contact with a coating comprising a plurality of dry core-shell particles, wherein a shell of dry core-shell particles comprises the non-fluorinated nanoparticle in contact with the silicon-based polymer, and wherein non-fluorinated nanoparticle and the silicon-based polymer are as described hereinabove.

In some embodiments, the plurality of dry core-shell particles are hollow shaped particles having a hollow core. In some embodiments, the core of the dry core-shell particles comprises a lumen.

In some embodiments, the plurality of dry core-shell particles is in a form of a hollow sphere, a crater, a quasi-sphere, a quasi-elliptical sphere, or any combination thereof.

In some embodiments, the article comprises a coating layer in contact with the substrate. In some embodiments, the article comprises a coating layer bound or adhered to the substrate, wherein the coating layer comprises the plurality of dry core-shell particles.

In some embodiments, the coating layer comprises the silicon-based polymer of the invention in contact with the hydrophobic particles of the invention, wherein a w/w a ratio between hydrophobic particles to the silicon-based polymer within the coating layer is between 2:1 and 1:2, between 2:1 and 1.5:1, between 1.5:1 and 1:1, between 1:1 and 1:1.5, between 1:1.5 and 1:2, including any range therebetween.

In some embodiments, the substrate is selected from, a polymeric substrate, glass substrate, a metallic substrate, a paper substrate, a carton substrate, a polystyrene substrate, a tissue-based substrate, a brick wall, a sponge, a textile, a non-woven fabric, or wood.

In some embodiments, the substrate is a polymeric substrate comprising a polyolefin.

In some embodiments, the substrate is selected from a polyethylene substrate or a polypropylene substrate. In some embodiments, the substrate is non-woven polypropylene.

In some embodiments, the coating adheres to the substrate.

In some embodiments, the coating layer is characterized by an average thickness of 100 nm to 500 μm, 100 nm to 400 μm, 100 nm to 300 nm, 300 nm to 500 nm, 500 nm to 1000 nm, 250 nm to 400 μm, 500 nm to 400 μm, 900 nm to 400 μm, 1 μm to 400 μm, 10 μm to 400 μm, 50 μm to 400 μm, 100 μm to 400 μm, 250 μm to 400 μm, 10 nm to 100 μm, 25 nm to 100 μm, 50 nm to 100 μm, 100 nm to 100 μm, 250 nm to 100 μm, 500 nm to 100 μm, 900 nm to 100 μm, 1 μm to 100 μm, 10 μm to 100 μm, 50 μm to 100 μm, 10 nm to 10 μm, 25 nm to 10 μm, 50 nm to 10 μm, 100 nm to 10 μm, 250 nm to 10 μm, 500 nm to 10 μm, 900 nm to 10 μm, or 1 μm to 10 μm, including any range therebetween.

In some embodiments, the coating layer is characterized by a water contact angle (WCA) in the range of 130° to 180°, 130° to 165°, 130° to 160°, 130° to 150°, or 135° to 165°, including any range therebetween.

In some embodiments, the article is characterized by a water contact angle of at least 130°. In some embodiments, the article is characterized by a water contact angle in the range of 100° to 180°, 110° to 180°, 120° to 180°, 1300 to 180°, 130° to 168°, 130° to 165°, 130° to 160°, 130° to 150°, or 135° to 165°, including any range therebetween.

In some embodiments, the article is characterized by a surface contact angle of more than 130°. In some embodiments, the coating layer is characterized by a surface contact angle of more than 130°, 140°, 150°, including any value therebetween.

In some embodiments, the coating layer is characterized by a roll-off (RA) angle of less than 30°, less than 25°, less than 20°, less than 15°, less than 10°, less than 9°, less than 8°, less than 7, less than 6°, or less than 5°, less than 3° including any value therebetween. In some embodiments, the coating layer is characterized by a RA angle of 100 to 0°, 100 to 3°, 100 to 5°, 9° to 0°, 9° to 3°, 9° to 5°, 8° to 1°, 8° to 3° 8° to 5° 5° to 3° 3° to 0°, 10 to 0°, including any range therebetween. In some embodiments, the article is characterized by a RA angle of less than 10°, less than 9°, less than 8°, less than 7, less than 6°, or less than 5°, including any value therebetween.

In some embodiments, the coating layer is stable at a temperature range of −100° C. to 200° C., −50° C. to 200° C., −10° C. to 200° C., 0° C. to 200° C., 10° C. to 200° C., 50° C. to 1500° C., 100° C. to 200° C., −100° C. to 200° C., −50° C. to 200° C., −10° C. to 200° C., 0° C. to 200° C., 10° C. to 100° C., 100° C. to 200° C., including any range therebetween.

In some embodiments, the coating layer is characterized by a transparency of 30% to 100%, 40% to 100%, 50% to 100%, 60% to 100%, 70% to 100%, 80% to 100%, 30% to 99.9%, 40% to 99.9%, 50% to 99.9%, 60% to 99.9%, 70% to 99.9%, 80% to 99.9%, 30% to 99%, 40% to 99%, 50% to 99%, 60% to 99%, 70% to 99%, 80% to 99%, 30% to 98%, 40% to 98%, 50% to 98%, 60% to 98%, 70% to 98%, 80% to 98%, 30% to 95%, 40% to 95%, 50% to 95%, 60% to 95%, 70% to 95%, 80% to 95%, 30% to 90%, 40% to 90%, 50% to 90%, 60% to 90%, 70% to 90%, or 80% to 90%, including any range therebetween.

In some embodiments, the coating layer is a substantially uniform coating layer, characterized by a substantially uniform density and/or surface pattern. In some embodiments, the coating layer is characterized by a pattern comprising microstructures and nanostructures. In some embodiments, the plurality of microstructures are defined by the plurality of dry core-shell particles of the invention.

In some embodiments, the coating layer comprises a plurality of hydrophobic nanoparticles bound or adhered to a plurality of microstructures. In some embodiments, the plurality of hydrophobic nanoparticles are on top of plurality of microstructures. In some embodiments, each of the plurality of microstructures is at least partially coated with the plurality of hydrophobic nanoparticles. In some embodiments, the plurality of hydrophobic nanoparticles and the silicon-based polymer of the invention are distributed in a form of a dense layer or in a form of a honeycomb within the coating layer.

In some embodiments, the microstructures have a spherical shape, a quasi-spherical shape, a quasi-elliptical sphere, an irregular shape, or any combination thereof. In some embodiments, the microstructures are in a form of a plurality of craters. In some embodiments, the shape of the plurality of microstructures is substantially predefined by the shape of the plurality of dry core-shell particles of the invention.

In some embodiments, the coating layer comprises the plurality of dry core-shell particles of the invention distributed on a surface of the substrate in a form of a dense layer or in a form of a honeycomb structure. In some embodiments, the coating layer comprises a porous layer. In some embodiments, the coating layer is in a form of a dense layer (e.g., continuous layer) comprising the plurality of dry core-shell particles and/or the plurality of hydrophobic nanoparticles and the silicon-based polymer homogeneously distributed within the coating layer. In some embodiments, dry core-shell particles and/or the plurality of hydrophobic nanoparticles are in close proximity to each other within the coating layer. In some embodiments, the dense layer is in a form of continuous porous layer, comprising a matrix of the hydrophobic nanoparticles and the silicon-based polymer, and a plurality of pores (void space). In some embodiments, the pores are micron-sized pores.

In some embodiments, the article comprises an outer surface and an inner surface, wherein the outer surface is in contact with or bound to the coating layer, as described herein. In some embodiments, the outer surface of the article is characterized by a surface morphology comprising a plurality of craters. In some embodiments, the outer surface of the article comprises a plurality of craters and/or a plurality of spheres or quasi-spheres.

One skilled in the art will appreciate, that the craters can obtain any shape. The craters may have the same shape or at least a portion of the plurality of craters may have a different shape.

In some embodiments, the craters are spherically shaped. In some embodiments, the craters are elliptically shaped. In some embodiments, the craters are conically shaped. In some embodiments, any one of the craters is randomly shaped. In some embodiments, the inner surface is substantially devoid of craters. In some embodiments, the plurality of craters forms a pattern on top of the outer surface. In some embodiments, the pattern is any pattern, such as a rectangular, elliptical, round, or horseshoe including any combination thereof. In some embodiments, the plurality of craters is randomly distributed within the outer surface of the article.

In some embodiments, the plurality of craters is characterized by any geometric form or shape. In some embodiments, the plurality of craters has substantially round shape or substantially elliptical shape. In some embodiments, the plurality of craters has an irregular shape. In some embodiments, the plurality of craters has a random shape.

In some embodiments, the plurality of craters are characterized by a rim diameter. In some embodiments, the rim diameter is between 1 and 500 μm, between 1 and 10 μm, between 10 and 20 μm, between 20 and 30 μm, between 30 and 50 μm, between 50 and 70 μm, between 70 and 100 μm, between 100 and 120 μm, between 100 and 300 μm, between 100 and 150 μm, between 150 and 200 μm, between 200 and 250 μm, between 250 and 300 μm, between 300 and 400 μm, between 400 and 500 μm, including any value therebetween, wherein the rim diameter defines the diameter of the opening on top of the crater.

In some embodiments, the crater is characterized by a height. In some embodiments, a surface roughness is predetermined by mean height value. As used herein, the term “rim diameter” is referred to a diameter measured at a top of the crater.

In some embodiments, the average height of the plurality of craters is in a range from 1 to 500 μm, from 10 nm to 1 μm, from 100 nm to 1 μm, from 10 to 30 μm, from 10 to 20 μm, from 20 to 50 μm, from 50 to 100 μm, from 100 to 200 μm, from 200 to 500 μm, including any range or value therebetween.

In some embodiments, the particle size of the microstructures (e.g., rim diameter of the craters) is comparable with the diameter of the corresponding core-shell particles of the liquid described herein. In some embodiments, an average particle size of the microstructures is 0.1% to 10%, 0.2% to 10%, 0.3% to 10%, 0.4% to 10%, 0.5% to 10%, 0.1% to 8%, 0.1% to 5%, or 0.1% to 1%, of the average diameter of the corresponding core-shell particles in the emulsion, including any range therebetween. In some embodiments, an average particle size of the microstructures is 0.5 μm to 100 μm, 0.9 μm to 100 μm, 1 μm to 100 μm, 2 μm to 15 μm, 2.5 μm to 15 μm, 0.5 μm to 10 μm, 0.9 μm to 10 μm, 1 μm to 10 μm, 2 μm to 10 μm, 2.5 μm to 10 μm, 10 μm to 20 μm, 30 μm to 40 μm, 40 μm to 50 μm, 50 μm to 60 μm, 60 μm to 70 μm, 70 μm to 80 μm, 80 μm to 100 μm, including any range therebetween.

As used herein, the “particle size” for a spherical particle can be defined by its diameter. With irregular and non-spherical particles, described herein, a volume-based particle size can be approximated by the diameter of a sphere that has the same volume as the non-spherical particle. Similarly, an area-based particle size can be approximated by the diameter of the sphere that has the same surface area as the non-spherical particle.

In some embodiments, the nanostructures comprise hydrophobic nanoparticles of the invention (e.g., modified silica nanoparticles). In some embodiments, the nanostructures comprise alkyl-silylated hydrophobic silica nanoparticles. In some embodiments, the nanostructures comprise alkylated silica nanoparticles.

In some embodiments, the nanostructures consist essentially of the hydrophobic nanoparticles of the invention.

In some embodiments, the surface roughness of the coating layer is between 1 and 1000 nm, between 1 and 10 nm, between 10 and 1000 nm, between 10 nm and 10 μm, between 10 nm and 5 μm, between 10 nm and 2 μm, between 2 and 5 μm, between 10 nm and 1 μm, between 100 nm and 10 μm, between 100 nm and 5 μm, between 100 nm and 2 μm, between 100 nm and 1 μm, between 200 nm and 10 μm, between 200 nm and 5 μm, between 200 nm and 1 μm, between 10 nm and 10 μm between 100 nm and 1000 nm, between 10 and 100 nm, between 10 and 20 nm, between 10 and 50 nm, between 20 and 50 nm, between 50 and 100 nm, between 10 and 200 nm, between 100 and 200 nm, between 200 and 300 nm, between 300 and 400 nm, between 400 and 500 nm, between 500 and 600 nm, between 600 and 700 nm, between 700 and 800 nm, between 800 and 1000 nm, including any range or value therebetween.

In some embodiments, the composition comprises an adhesiveness property to a surface. In some embodiments, the coating layer comprises an adhesiveness property to a surface.

In some embodiments, the coating layer is an anti-microbial coating.

In some embodiments, the coating layer has at least one characteristic selected from: an anti-fungal coating, an anti-microbial coating, an anti-insect coating, an anti-viral coating, an anti-mold coating, a plant protective coating, and a pesticide coating.

In some embodiments, the anti-microbial coating is capable of reducing at least one of (i) biofilm formation and (ii) microbial load by at least 10%, at least 20%, at least 30%, at least 40%, at least 50%, at least 70%, at least 100%, including any range between compared to a control. In some embodiments, the control is the same substrate being devoid of the coating layer of the invention. In some embodiments, the anti-microbial coating is capable of reducing microbial load by a factor ranging between 2 and 20, between 2 and 5, between 5 and 7, between 7 and 10, between 10 and 12, between 12 and 15, between 15 and 20, including any range between. In some embodiments, the anti-microbial coating is capable of reducing microbial load by a factor ranging between 20 and 100.000, between 20 and 100, between 100 and 1000, between 1000 and 10.000, between 10.000 and 100.000, between 100.000 and 1.000.000, including any range between. In some embodiments, reducing is compared to control (e.g., a similar article devoid of the coating disclosed herein).

In some embodiments, the anti-microbial coating is capable of preventing biofilm formation on top of the coated surface.

As used herein the term “biofilm” refers to any three-dimensional, matrix-encased microbial community displaying multicellular characteristics. Accordingly, as used herein, the term biofilm includes surface-associated biofilms as well as biofilms in suspension, such as flocs and granules. Biofilms may comprise a single microbial species or may be mixed species complexes, and may include bacteria, or other microorganisms.

As used herein, the term “reducing” in any grammatical form thereof, is related to reduction of any type of biofilms (e.g., pellicle, bundle) on or within the article, as compared to a similar article devoid of the coating described herein. In some embodiments, the biofilm is essentially nullified (e.g., prevented) or is reduced by at least 20%, at least 30%, at least 40%, at least 50%, at least 60%, at least 70%, at least 80%, at least 90%, including any value therebetween.

In some embodiments, the article of the invention comprises a coating layer characterized by reduced microbial load and/or reduced biofilm formation, wherein reduced is by a factor ranging between 2 and 20, between 20 and 100.000, between 20 and 100, between 100 and 1000, between 1000 and 10.000, between 10.000 and 100.000, between 100.000 and 1.000.000, including any range between. In some embodiments, reduced microbial load refers to a CFU number of the microbe on or within the coating layer, compared to control (e.g., a similar article devoid of the coating disclosed herein). In some embodiments, the microbial load and/or reduced biofilm formation of the control and of the article of the invention are assessed upon exposing thereof to a similar concentration (e.g., CFU) of a microbe.

In some embodiments, the coating layer is characterized by a microbial load of between 1 and 104 CFU per cm², between 1 and 10 CFU per cm², between 10 and 100 CFU per cm², between 100 and 10³ CFU per cm², between 10³ and 10⁴ CFU per cm², between 10³ and 10⁵ CFU per cm², including any range between.

In some embodiments, the biofilm comprises bacteria. In some embodiments, the microbe comprises bacteria and/or fungi. In some embodiments, the bacteria are selected from Gram positive bacteria and/or Gram-negative bacteria. In some embodiments, the bacteria are spore forming bacteria. In some embodiments, the bacteria are thermophilic bacteria. In some embodiments, the term “microbe” refers to any prokaryotic organism, including those within all of the phyla in the Kingdom Prokaryote. It is intended that the term “bacteria” encompasses all microorganisms considered to be bacteria including Escherichia, Mycoplasma, Chlamydia, Actinomyces, Streptomyces, and Rickettsia. All forms of bacteria are included within this definition including cocci, bacilli, spirochetes, spheroplasts, protoplasts, etc.

In some embodiments, the bacteria are of the genus Escherichia. In some embodiments, the bacteria is or comprises E. coli.

In some embodiments, the coating layer according to the present invention, is stable to climatic changes. In some embodiments, the coating layer is stable to temperature changes, heat, cold, UV radiation and atmospheric corrosive elements. In some embodiments, the characteristics of the coating layer are not affected or altered by climatic changes as described herein. In some embodiments, the article according to the present invention, is stable to climatic changes. In some embodiments, the article is stable to temperature changes, heat, cold, UV radiation and atmospheric corrosive elements. In some embodiments, the characteristics of the article are not affected or altered by climatic changes as described herein.

### The Method

According to some embodiments, the present invention provides a method of coating a substrate. In some embodiments, the method comprises the steps of: i) providing a substrate; and ii) contacting the substrate with the composition as described herein (e.g., W/O or O/W Pickering emulsion), thereby forming a coating layer on the substrate. In some embodiments, the method of the invention further comprises providing the coating layer under conditions appropriate for drying of the coating layer, thereby obtaining a dry coating layer on top of the substrate.

In some embodiments, conditions appropriate for drying comprise exposing the layer to any one of vacuum, thermal irradiation, microwave irradiation, infra-red irradiation, and UV-visible irradiation, or any combination thereof.

In some embodiments, contacting is selected from the group comprising: spin coating, roll coating, spray coating, and kiss coating, air knife coating, anilox coater, flexo coater, gap coating, dip coating, rod coating, and dipping.

In some embodiments, the coated substrates are placed in hot air oven. In some embodiments, the substrates are places in a hot air oven at a temperature ranging from 20° C. to 180° C., 25° C. to 180° C., 30° C. to 180° C., 30° C. to 150° C., 30° C. to 90° C., 30° C. to 80° C., 30° C. to 70° C., 30° C. to 60° C., 40° C. to 180° C., 40° C. to 150° C., 40° C. to 90° C., 40° C. to 80° C., 40° C. to 70° C., 40° C. to 60° C., 50° C. to 180° C., 50° C. to 150° C., 50° C. to 90° C., 50° C. to 80° C., 50° C. to 70° C., or 50° C. to 60° C., including any range therebetween. In some embodiments, the substrates are placed in hot air oven for a period of time in the rage of 1 hour to 24 hour, 2 hour to 24 hour, 3 hour to 24 hour, 5 hour to 24 hour, 6 hour to 24 hour, 1 hour to 12 hour, 2 hour to 12 hour, 3 hour to 12 hour, 5 hour to 12 hour, 6 hour to 12 hour, 1 hour to 8 hour, 2 hour to 8 hour, 3 hour to 8 hour, or 5 hour to 8 hour, including any range therebetween.

In some embodiments, the coated substrates are air dried.

In some embodiments, the substrate is selected from the group comprising: a polymeric substrate, a glass substrate, a tissue-based substrate, a metallic substrate, a paper substrate, a carton substrate, a brick wall, a sponge, a textile, a non-woven fabric, a polystyrene substrate, or wood.

In some embodiments, the polymeric substrate is selected from a polyethylene substrate or a polypropylene substrate. In some embodiments, the substrate is non-woven polypropylene.

In some embodiments, the coating adheres to the substrate. In some embodiments, the article is stable. In some embodiments, the article is stable upon exposure to UV radiation, IR radiation, visible light radiation, thermal radiation microwave radiation or any combination thereof.

As used herein the term “stable” refers to the capability of the article (e.g., a coated substrate) to maintain its structural and/or mechanical integrity such as being devoid of cracks and/or deformations. In some embodiments, the article is referred to as stable, if the article substantially maintains its structural and/or mechanical integrity under outdoor conditions such as a temperature −25 and 75° C., UV and/or visible light irradiation. In some embodiments, the stable article is rigid under outdoor conditions. In some embodiments, the stable article maintains its tensile strength and/or elasticity. In some embodiments, substantially is as described hereinbelow.

In some embodiments, the article is in a form of a film. In some embodiments, the article is in a form of a continuous layer. In some embodiments, the article is in a form of a dishware. In some embodiments, the article is in a form of a packaging material. In some embodiments, the article is in a form of a packaging article. In some embodiments, the article is in a form of a food packaging article. In some embodiments, the packaging material is for packaging an edible matter.

In some embodiments, the coated substrate has at least one characteristic selected from: an anti-fungal coating, an anti-microbial coating, an anti-insect coating, an anti-viral coating, an anti-mold coating, a plant protective coating, a pesticide coating.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method, or structure may include additional ingredients, steps and/or parts, but only if the additional ingredients, steps and/or parts do not materially alter the basic and novel characteristics of the claimed composition, method, or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “substantially” refers to at least 85%, at least 90%, at least 92%, at least 95%, at least 96%, at least 97%, at least 98%, at least 99% including any range or value therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical, and medical arts.

As used herein, the term “treating” includes abrogating, substantially inhibiting, slowing, or reversing the progression of a condition, substantially ameliorating clinical or aesthetical symptoms of a condition, or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

Various embodiments and aspects of the present invention as delineated hereinabove and as claimed in the claims section below find experimental support in the following examples.

### EXAMPLES

### Materials and Methods

### Polymeric Pickering Emulsion Preparation:

Pickering emulsions were prepared by utilizing hydrophobic silica NPs (Aerosil R972, with an estimated primary particle size of 16 nm, obtained from Evonik, Germany), Polydimethylsiloxane (PDMS) (Sylgard 184, obtained from DOW, USA) double-distilled water and toluene or xylene (analytical grade and were obtained from Fisher Scientific, UK).

First, 2 g PDMS was added to 198 ml of toluene or xylene and stirred until complete dissolution of the polymer. This step was performed at ambient temperature under stirring for 2 hours.

Subsequently, the silica NPs were dispersed in 5 mL of the PDMS solution by sonication for 5 min, so as to result in a silica content of 1 wt. % in the dispersion. Then, distilled water was added so as to obtain w/o ratios of 40:60 or 50:50 vol %, respectively. The mixture was sonicated for another 1-30 min, so as to obtain a stable emulsion.

The inventors successfully utilized toluene/water or xylene/water solvent mixtures for the preparation of stable Pickering emulsions disclosed herein. A workable w/w range of toluene/xylene to water was between about 50:50 and about 80:20. A workable w/w range of hydrophobic silica nanoparticles (e.g., Aerosil R 972) within the Pickering emulsions was between about 0.6 and about 2%.

### Confocal Laser Scanning Microscopy and Image Analysis:

The samples were analyzed by laser scanning confocal microscopy (Leica, Wetzlar, Germany) using 552 nm excitation light. Fluorescence emission of Nile red was recorded at 565-660 nm. The droplet average diameter was measured for every sample by the particles analysis tool of Fiji software based on confocal microscopy images.

### Preparation of Coated Surfaces:

As prepared emulsions were applied on the surface (1×1 cm, 110 μl) via spin or roll coating method. In order to enable rapid evaporation of emulsions, the surfaces were placed in a hot air oven maintained at 80° C. for 4±1 hours.

### Morphological Characterization:

Scanning Electron Microscope (SEM) images of fabricated coatings were obtained using a model MIRA3 from TESCAN at a 5 KV and secondary electron detector. In order to prepare samples for SEM analysis, the Pickering emulsion coated surface was deposited onto an aluminum sample holder covered with carbon tape. The samples were sputter-coated with a gold-palladium, to reduce charging effects. The atomic force microscope (AFM) analyses were performed with a commercial AFM (JPK Nanowizard III), operated with a tapping mode. Silicon cantilevers coated with aluminum were used at a spring constant of ˜40 N/m were used and were driven at a frequency of 250 KHz in air. All AFM experiments were carried out at room temperature.

### Surfaces Wetting Analysis:

To study the surface wettability, static water contact angles (CAs) and Roll-off angles (RAs) were measured at room temperature using a drop shape analyzer (DSA 100 Kruss). 5 μl water (AR Grade) droplets dispensed on the coatings surface and side view images of them were captured. For measuring, water RAs, the stage was tilted followed by deposition of 5 μl water droplets onto the surface. RAs were recorded as a stage tilt angle at which all the water droplets started to roll away from the coating surface. To prove the reproducibility of the results, eighteen measurements were done on two different samples that were fabricated under identical conditions.

### Cryogenic-Scanning Electron Microscopy (Cryo-SEM):

Cryogenic-scanning electron microscopy analysis was performed on a JSM-7800F Schottky field-emission SEM microscope (Jeol Ltd., Tokyo/Japan), equipped with a cryogenic system (Quorum PP3010, Quorum Technologies Ltd., Laughton/United Kingdom). Liquid nitrogen was used in all heat exchange units of the cryogenic system. A small droplet of an emulsion was placed on the sample holder, between two rivets, quickly frozen in liquid nitrogen for a few seconds, and transferred to the preparation chamber where it was fractured (at −140° C.). The revealed fractured surface was sublimed at (−85° C. for 20 min) to eliminate any presence of condensed ice and then coated with platinum (10 mA for 50 seconds). The temperature of the sample was kept at −140° C. Images were acquired with a low electron detector (LED) at an accelerating voltage of 5.0 kV and a working distance of (4 mm).

### Example 1

### Polysiloxane-Based Pickering Emulsion

The Pickering emulsions were prepared as described above, using 1 wt % of PDMS dissolved in an organic solvent (e.g., xylene, and/or toluene).

Various organic phase to aqueous phase ratios (o/w ratio) have been examined so as to evaluate a range of o/w ratios appropriate for the formation of the stable emulsion. In an exemplary embodiment, stable emulsion have been prepared by utilizing (i) water in toluene (w/o ratio, 40:60) with 1 wt. % silica and PDMS; and (ii) water in xylene (w/o ratio, 50:50) with 1 wt. % silica and PDMS.

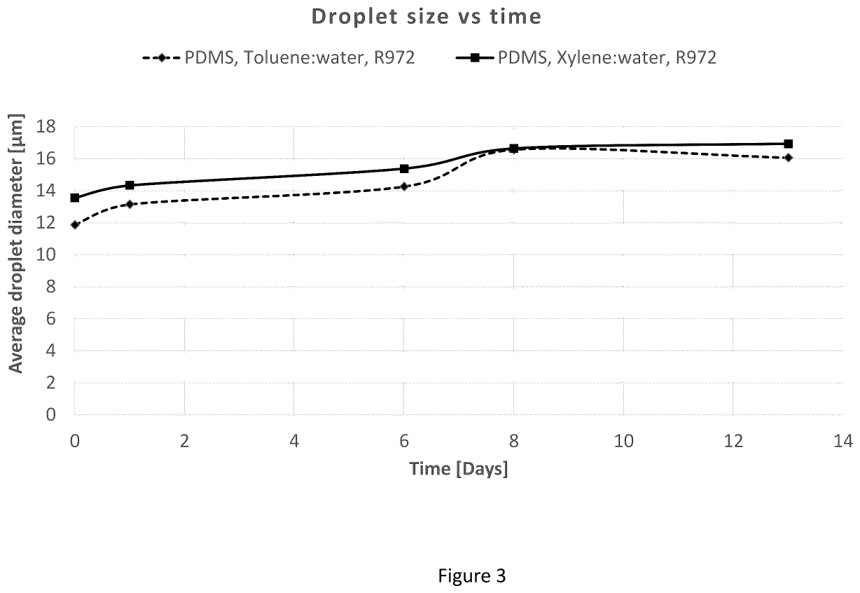

Emulsion stability was examined by the appearance of phase separation and droplet size measurement tracing for 14 days. During this time period, the emulsions were almost completely devoid of phase separation, and the mean size of the droplets remained almost constant within a range of between 10 and 18 um (FIG. 3).

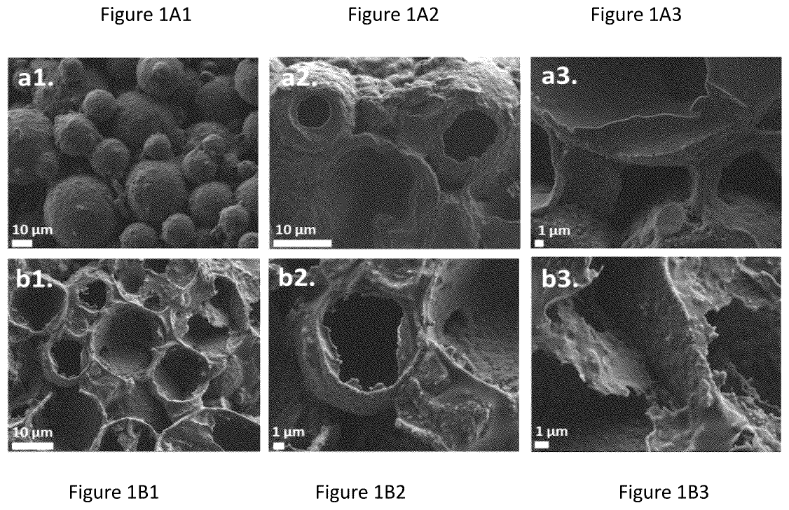

Additionally, the emulsions of the invention were analyzed by Cryo-SEM (FIG. 1). As represented by FIG. 1, the particles are substantially in a form of spheres optionally comprising an opening. The emulsions were considered as Pickering emulsions, since the silica nanoparticles were observed on the interphase between the water droplets and the solvent continuous phase.

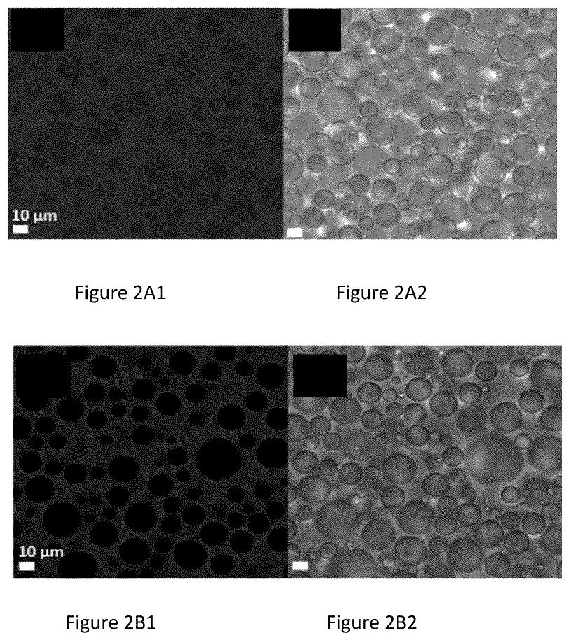

The emulsions as described herein were classified as a w/o emulsion based on the micrograms obtained by confocal microscopy, wherein the organic phase was visualized by addition of Nile red fluorescent dye (FIG. 2).

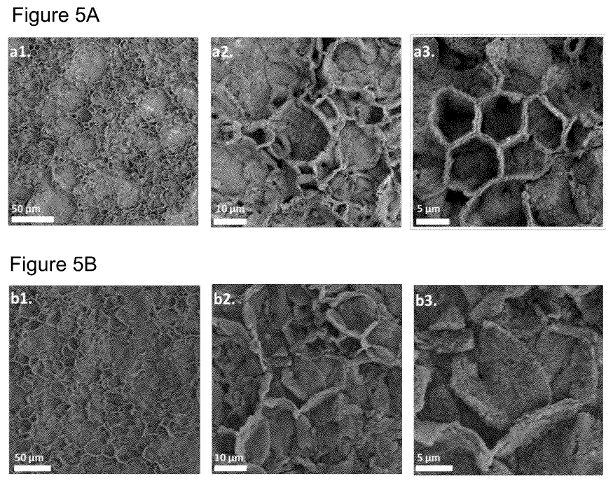

The emulsions of the invention were applied (e.g., by spin coating) on top of polypropylene (PP) substrate, so as to obtain a coated PP layer. Typically, an emulsion of the invention (between 90 and 150 ul) was applied on top of a PP substrate (11 cm²). Upon drying (e.g., for at least 3 h at a temperature of between 60 and 100° C.), a “honeycomb” like structures of silica and PDMS has been obtained on top of the coated samples, as exhibited by SEM micrographs (FIG. 5 a1.-b3.). In some embodiments, the drying was performed by evaporation of the solvents (e.g., water and of the organic solvent).

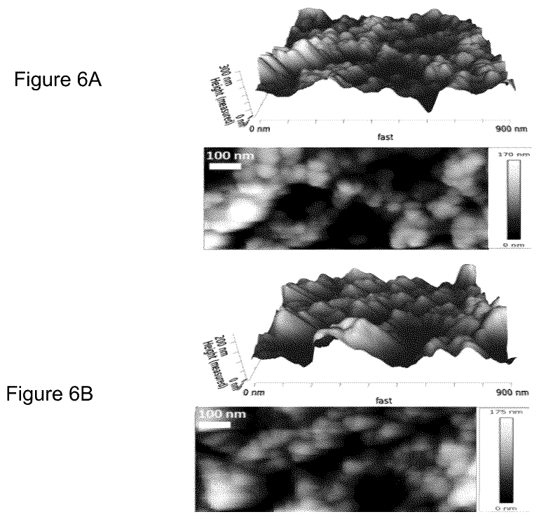

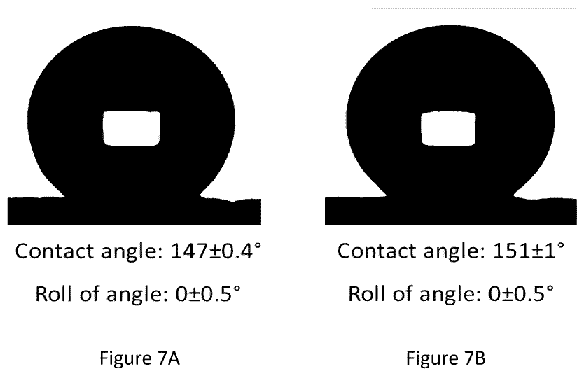

Furthermore, the coated surfaces were analyzed by AFM showing a surface roughness of and of nm less than 300 nm (FIG. 6). The calculated surface roughness values (Ra) of the coated surfaces were 52.80±16.00 nm for toluene/water, and 87.60±4.00 nm for xylene/water-based Pickering emulsions, respectively. The measured roll-off and contact angles of both coated surfaces were of 0±0.5° and of between 145 and 155° respectively for both toluene/water and xylene/water-based emulsions (FIG. 7). Accordingly, the exemplified Pickering emulsions resulted in superhydrophobic coatings on top of polyolefin-based substrate.

The inventors tested the abovementioned Pickering emulsions consisting solely of the solvents and silica nanoparticles (i.e., devoid of PDMS). Although a mixture of water/toluene or water/xylene together with hydrophobic silica nanoparticles resulted in the formation of Pickering emulsions, the resulting emulsion did not form a stable coating upon application thereof on the polymeric substrate (e.g., PP).

Accordingly, the claimed invention exhibits advantageous properties, such as a formation of a stable coating on top of a polyolefin-based substrate, compared to compositions without the silicon-based polymer.

### Example 2

### Reduction of Bacterial Loading on the Coated Substrate

The coated substrates were prepared as described in Example 1. Finally, the superhydrophobic surfaces were examined for their ability to reduce bacterial loading and to prevent or inhibit biofilm formation, using E. coli as the experimental model. Evaluation of bacterial loading on top of the coated substrate was performed according to a biofilm assay, as described hereinbelow.

Bacteria were grown overnight in MH growth medium. The bacteria were diluted in MH 1% to obtain a working solution with an OD595 of 0.3, approximately corresponding to 3×10\hat{ }8 colony forming units (CFU). 1 ml of the stock solution of the bacteria was transferred into each well in a 24-well plate (SPL Life Sciences). The samples (squares of 1 cm×1 cm) were added into the wells. The plates were incubated for 20 h at 37° C. The samples were rinsed 3 times with distilled water to remove the planktonic cells. The attached cells were scraped from the fabrics using 250 μl of MH 1% by a cell scraper (Greiner Bio-one). The samples were then taken into 15 ml tubes and the volume was completed to 2 ml using MH 1%. The tubes were sonicated for 20 min in a bath sonicator (mrc), 37 kHz and then vortexed for 30′. Following this, 200 μl were transferred into a 96-well plate. Other wells were filled with 180 μl of MH. Serial dilutions were conducted, and the bacteria were spotted onto LB agar plates and incubated at 37° C. for 20 h. The growth of bacteria was determined by counting the viable cells.

Furthermore, bacterial loading on top of the coated substrates was estimated by SEM, as described hereinbelow.

Biofilm of E. coli was developed as described above (biofilm assay). Following biofilm growth, the samples were rinsed 3 times with distilled water to remove the planktonic cells and then fixated for 1 hour with Glutaraldehyde/Paraformaldehyde Sodium Cacodylate buffer (Belgar). Then, the samples were washed 3 times with PBS following a dehydration step in which ethanol (Romical) at increasing concentrations was applied for 10 minutes in each cycle: 50%, 70%, 96%, and 100%. Each concentration was administrated for 2 cycles. Then, the ethanol was removed, and the samples were immersed in Hexamethyldisilazane (HMDS, Sigma) for 5 minutes. After the HMDS treatment, the samples were left to air dry. Then the samples were gold-coated (Q150R quorum) and viewed with a Quanta FEG, FEI.

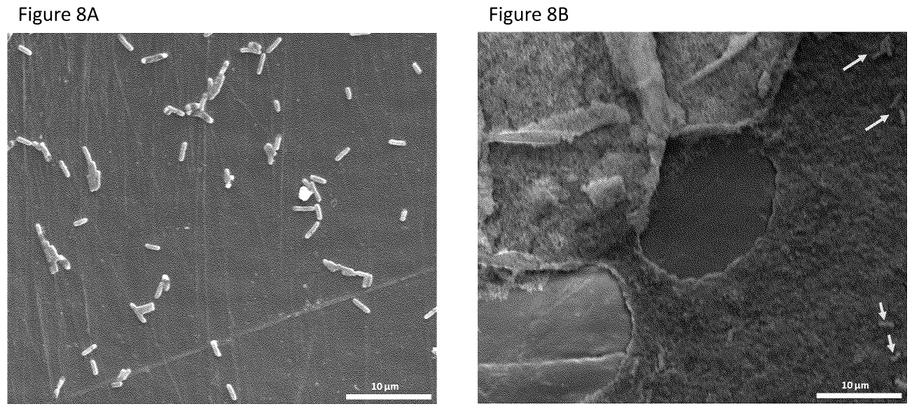

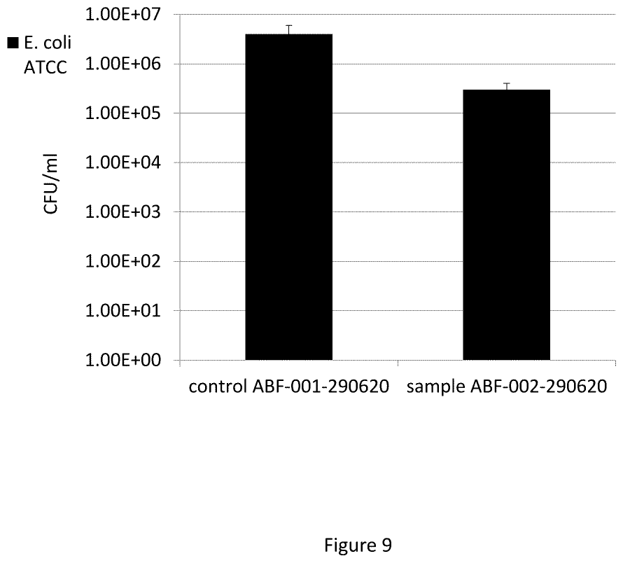

As represented in FIG. 9, bacterial loading (E. coli) on top of the coated substrates was reduced by an order of magnitude, compared to the untreated substrate. Both toluene-, and xylene-based emulsions demonstrated anti-bacterial properties, when applied on top of the polymeric substrate. Additionally, as demonstrated by FIG. 8, coated PP substrate was characterized by significantly reduced bacterial attachment, compared to the untreated substrate. Furthermore, coated PP substrates (either Xylene, or Toluene-based coatings) significantly abolished the biofilm formation of E. coli (FIG. 8) as almost no bacteria were observed on the surfaces (FIG. 8B). Quantifying the bacteria population on the surfaces resulted in the average reduction of between 75 and 96% for the coated substrates.

In some embodiments, the coating implemented herein resulted in the suppression or prevention of bacterial attachment to the coated substrate and/or biofilm formation.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent, or patent application was specifically and individually indicated to be incorporated herein by reference. In addition, citation, or identification of any reference in this application shall not be construed as an admission that such reference is available as prior art to the present invention. To the extent that section headings are used, they should not be construed as necessarily limiting.

1. A composition, comprising core-shell particles dispersed within a hydrophobic solvent, wherein:
a. the core of said core-shell particles comprises an aqueous solution;
b. the shell of said core-shell particles comprises a hydrophobic non-fluorinated nanoparticle in contact with a silicon-based polymer;
c. a w/w ratio of said silicon-based polymer to said non-fluorinated nanoparticle within said shell is between 3:1 and 1:3; and
d. said hydrophobic non-fluorinated nanoparticle comprises a chemically modified metal oxide nanoparticle.

2. The composition of claim 1, wherein chemically modified metal oxide nanoparticle comprises a metal oxide selected from nanoclay, SiO₂, TiO₂, Al₂O₃, Fe₂O₃, ZnO, and ZrO or any combination thereof.

3. The composition of claim 1, wherein the chemically modified metal oxide nanoparticle comprises a substituent covalently bound to the metal oxide, wherein the substituent is selected from (C1-C20)alkyl, (C1-C20)haloalkyl, halo, (C1-C20) haloalkylsilyl, (C1-C20)alkylsilyl group, vinyl, epoxy, a cycloalkane, an alkene, an alkyne, an ether, an alkyl-halosilyl group, alkyl-hydroxysilyl group, haloalkyl-hydroxysilyl group, halo-hydroxysilyl group and a siloxane group, or any combination thereof, and wherein halo is selected from Cl, Br, and I; and wherein said silicon-based polymer is represented by Formula: [Si(R₁R₂)—O—]ₙ, wherein:
n is an integer ranging from 100 to 150000;
R₁, R₂ or both are selected from the group comprising: hydrogen, (C1-C20) alkyl group, (C1-C20) alkoxy group, an aryl group, a cycloalkyl group, or any combination thereof, and wherein at least one of R1 and R2 is not hydrogen.

4. (canceled)

5. The composition of claim 2, wherein said silicon-based polymer is an a alkylated siloxane polymer, optionally wherein said silicon-based polymer comprises PDMS; and wherein the metal oxide is SiO₂.

6. The composition of claim 1, wherein a w/w concentration of said core-shell particle within said composition is between 30% and 90%; and wherein a w/w concentration of said silicon-based polymer within said composition is between 0.1 and 10%.

7. (canceled)

8. The composition of claim 1, wherein a w/w concentration of said non-fluorinated nanoparticle within said composition is between 0.1 and 20% and wherein a w/w ratio of said aqueous solution to said hydrophobic solvent within said composition is between 0.5:1 and 1:0.5.

9. (canceled)

10. (canceled)

11. The composition of claim 1, wherein said core-shell particle has an average diameter between 1 μm and 50 μm; wherein said shell has a thickness of 10 nm to 500 nm; optionally wherein said core-shell particle is in a form of a sphere; further optionally wherein said core-shell particle is in a form of a colloidosome.

12. (canceled)

13. (canceled)

14. (canceled)

15. The composition of claim 1, wherein said composition is selected from the group consisting of an emulsion, a dispersion, or any combination thereof; and wherein said emulsion is selected from water in oil Pickering emulsion, and oil in water Pickering emulsion.

16. (canceled)

17. The composition of claim 1, wherein said hydrophobic solvent is selected from an aromatic hydrocarbon, an aliphatic hydrocarbon or both; and wherein said aromatic hydrocarbon is selected from the group consisting of toluene, ethylbenzene, xylene, chlorobenzene, styrene, dichlorobenzene, nitrobenzene, trimethylbenzene, trichlorobenzene or any combination thereof.

18. (canceled)

19. An article comprising: a substrate in contact with a coating comprising a plurality of microstructures, and wherein each microstructure comprises non-fluorinated nanoparticles in contact with a silicon-based polymer; and wherein each of said non-fluorinated nanoparticles comprises a chemically modified metal oxide nanoparticle.

20. The article of claim 19, wherein said coating is in a form of a coating layer characterized by a substantially uniform thickness; and wherein said metal oxide comprises nanoclay, SiO₂, TiO₂, Al₂O₃, Fe₂O₃, ZnO, and ZrO or any combination thereof.

21. (canceled)

22. The article of claim 19, wherein the chemically modified metal oxide nanoparticle comprises a substituent covalently bound to the metal oxide nanoparticle, wherein the substituent is selected from (C1-C20)alkyl, (C1-C20)haloalkyl, halo, (C1-C20) haloalkylsilyl, (C1-C20)alkylsilyl group, vinyl, epoxy, a cycloalkane, an alkene, an alkyne, an ether, an alkyl-halosilyl group, alkyl-hydroxysilyl group, haloalkyl-hydroxysilyl group, halo-hydroxysilyl group and a siloxane group, or any combination thereof, and wherein halo is selected from Cl, Br, and I: and wherein said silicon-based polymer is represented by Formula: [SiR₁R₂—O]ₙ, wherein:
n is an integer ranging from 100 to 150000;
R1, R2 or both are selected from the group comprising: hydrogen, (C1-C20) alkyl group, (C1-C20) alkoxy group, an aryl group, a cycloalkyl group, or any combination thereof, and wherein at least one of R1 and R2 is not hydrogen; optionally wherein said silicon-based polymer is an alkylated siloxane polymer, optionally comprising PDMS, and wherein a w/w ratio between PDMS and said non-fluorinated nanoparticles within the coating is between 3:1 and 1:3.

23. (canceled)

24. (canceled)

25. The article of claim 19, wherein a shape of said plurality of microstructures is in a form of a hollow sphere, a hollow hemisphere, a crater, a quasi-sphere, a quasi-elliptical sphere, or any combination thereof, optionally wherein said microstructures are distributed in a form of a dense layer or in a form of a honeycomb within the coating.

26. (canceled)

27. The article of claim 19, wherein said substrate is selected from, a polymeric substrate, a glass substrate, a metallic substrate, a fiber, a paper substrate, a brick wall, a sponge, a textile, a woven fabric, a non-woven fabric, and wood, or any combination thereof; optionally wherein said polymeric substrate comprises polyolefin.

28. (canceled)

29. The article of claim 19, wherein said coating is an anti-microbial coating wherein said anti-microbial coating is capable of reducing at least one of (i) biofilm formation and (ii) microbial load by at least 10%, compared to a control.

30. (canceled)

31. (canceled)

32. The article of claim 19, wherein said coating is characterized by at least one of: a water contact angle (WCA) of at least 130°; roll-off (RA) angle between 0 and 10°; stability at a temperature range of −100° C. to 200° C.; transparency of 30% to 100% surface roughness of less than 500 nm.

33.-36. (canceled)

37. A method for manufacturing the article of claim 19, comprising the steps of:
a. applying the composition of on at least a portion of a substrate, thereby obtaining a coating layer;
b. providing said coating layer under conditions appropriate for drying of said layer, thereby obtaining said article;
c. wherein said composition comprises core-shell particles dispersed within a hydrophobic solvent, wherein the core of said core-shell particles comprises an aqueous solution; the shell of said core-shell particles comprises a hydrophobic non-fluorinated nanoparticle in contact with a silicon-based polymer; a w/w ratio of said silicon-based polymer to said non-fluorinated nanoparticle within said shell is between 3:1 and 1:3; and said hydrophobic non-fluorinated nanoparticle comprises a chemically modified metal oxide nanoparticle.

38. The method of claim 37, wherein said conditions appropriate for drying comprise exposing said layer to any one of vacuum, thermal irradiation, microwave irradiation, infra-red irradiation, and UV-visible irradiation, or any combination thereof.

39. The method of claim 37, wherein said substrate is selected from a polymeric substrate, a glass substrate, a metallic substrate, a fiber, a paper substrate, a brick wall, a sponge, a textile, a woven fabric, a non-woven fabric, and wood, or any combination thereof.
